(19) United States
(12) Patent Application Publication
(10) Pub. No.: US 2026/0320454 A1
(43) Pub. Date: Oct. 15, 2026

(54) SYSTEMS AND METHODS FOR MULTI-LAYER CONSTRAINT TUNING FOR CONTROLLED LARGE LANGUAGE MODEL INFERENCE

(71) Applicant: Brown Bacon LLC, Ashland, NE (US)

(72) Inventors: Anthony Arnold, Ashland, NE (US); Aimee Arnold, Ashland, NE (US)

(21) Appl. No.: 19/643,230

(22) Filed: Apr. 9, 2026

Related U.S. Application Data
(60) Provisional application No. 63/786,701, filed on Apr. 10, 2025.
(60) Provisional application No. 63/786,742, filed on Apr. 10, 2025.

(51) Int. Cl. G06N 7/01

(52) U.S. Cl. CPC G06N 7/01

(57) ABSTRACT

A multi-layer constraint tuning architecture transforms structured input, controls a constraint-based inference, constructs an execution state, and reduces raw data exposure during model execution. The multi-layer constraint tuning architecture transforms the input data into a constrained inference execution state prior to model execution. The multi-layer constraint tuning architecture operates independently of modifications to model weights, enforces constraint-consistent inference behavior, and produces domain-consistent outputs.

### CROSS-REFERENCE

The present application claims the benefit under 35 U.S.C. § 119 of U.S. Provisional application 63/786,701, filed on Apr. 10, 2025, titled “ENHANCED AI SYSTEM FOR PRE- AND POST-OPERATIVE CARE;” and of U.S. Provisional application 63/786,742, filed on Apr. 10, 2025, titled “AI SYSTEM FOR DYNAMIC FOOD AND WINE PAIRING BASED ON TASTE PROFILING AND CONTEXTUAL FACTORS,” which are incorporated herein by reference in their entirety.

### TECHNICAL FIELD

The present disclosure generally relates to artificial intelligence systems and, more specifically, to systems and methods for controlling inference of probabilistic machine learning models.

### BACKGROUND

Large language models generate outputs based on probabilistic inference over trained model weights. Existing approaches to constraining large language models include prompt engineering, post-generation filtering, model fine-tuning, retrieval-augmented generation (RAG), rule-based systems, and governance and policy enforcement systems. These approaches to constraining large language models exhibit the following limitations: constraints are applied probabilistically rather than deterministically, constraint enforcement occurs during or after inference rather than prior to execution, fine-tuning requires modification of model weights, prompt-based systems lack structured constraint representation, retrieval-based systems inject external documents into model inputs, raw or semi-structured data is propagated through inference pipelines, sensitive or irrelevant data may be exposed, governance systems do not control inference-constrained inference execution state, and rule-based systems do not operate within probabilistic inference frameworks. While effective for general-purpose language generation, such models lack deterministic mechanisms for enforcing domain-specific constraints during inference. Accordingly, there exists a need for a system that enforces constraints prior to inference execution while controlling model behavior without modifying model weights.

In the context of healthcare informatics, patients receive educational materials such as pamphlets, brochures, or verbal instructions from medical staff regarding surgical procedures, symptoms, and recovery plans. The information is often presented in medical jargon, leading to patient confusion. Therefore, it would be advantageous to provide a device, system, and method that address the shortcomings described above.

In the context of food and wine recommendations, food and wine pairing is traditionally delivered through the expertise of human sommeliers, chefs, and culinary professionals. The process of food and wine pairing relies on subjective judgment, extensive personal experience, and established heuristics, such as human expertise, taste evaluation, context consideration, and iterative feedback. The process of food and wine pairing is inherently limited in scalability, requiring a one-on-one interaction between an expert and a client or consumer. Accessibility to such expertise is often restricted by geography or cost, making it less available to the general population. Therefore, it would be advantageous to provide a device, system, and method that address the shortcomings described above.

### SUMMARY

In some aspects, the techniques described herein relate to a system including: one or more processors; and a memory, wherein the one or more processors execute program instructions maintained on the memory causing the one or more processors to: receive input data; classify a domain of the input data; identify constraints associated with the domain; generate structured constraint representations from the input data and the constraints, wherein the input data is transformed into the structured constraint representations; apply a contextual weighting to the constraints in the structured constraint representations; construct a constrained inference execution state using the structured constraint representations; and execute a probabilistic model using the constrained inference execution state to generate an output.

It is to be understood that both the foregoing general description and the following detailed description are explanatory only and are not necessarily restrictive of the present disclosure. The accompanying drawings, which are incorporated in and constitute a part of the specification, illustrate subject matter of the disclosure. Together, the description and drawings serve to explain the principles of the disclosure.

### BRIEF DESCRIPTION OF THE DRAWINGS

Implementations of the concepts disclosed herein may be better understood when consideration is given to the following detailed description thereof. Such description makes reference to the included drawings, which are not necessarily to scale, and in which some features may be exaggerated and some features may be omitted or may be represented schematically in the interest of clarity. Like reference numerals in the drawings may represent and refer to the same or similar element, feature, or function. In the drawings:

FIG. 1A depicts a simplified block diagram of a system, in accordance with one or more embodiments of the present disclosure.

FIG. 1B depicts tools of a large language model of the system, in accordance with one or more embodiments of the present disclosure.

FIG. 2 depicts a flow diagram of a method, in accordance with one or more embodiments of the present disclosure.

FIG. 3A depicts a simplified block diagram of a system, in accordance with one or more embodiments of the present disclosure.

FIG. 3B depicts layers of a large language model of the system, in accordance with one or more embodiments of the present disclosure.

FIG. 4 depicts a flow diagram of a method, in accordance with one or more embodiments of the present disclosure.

FIG. 5 illustrates a simplified block diagram of a multi-layered constraint tuning (MLCT) architecture, in accordance with one or more embodiments of the present disclosure.

FIGS. 6A-6B illustrate a simplified flow diagram of the multi-layered constraint tuning (MLCT) architecture, in accordance with one or more embodiments of the present disclosure.

### DETAILED DESCRIPTION

Before explaining one or more embodiments of the disclosure in detail, it is to be understood that the embodiments are not limited in their application to the details of construction and the arrangement of the components or steps or methodologies set forth in the following description or illustrated in the drawings. In the following detailed description of embodiments, numerous specific details are set forth in order to provide a more thorough understanding of the disclosure. However, it will be apparent to one of ordinary skill in the art having the benefit of the instant disclosure that the embodiments disclosed herein may be practiced without some of these specific details. In other instances, well-known features may not be described in detail to avoid unnecessarily complicating the instant disclosure.

As used herein, a letter following a reference numeral is intended to reference an embodiment of the feature or element that may be similar, but not necessarily identical, to a previously described element or feature bearing the same reference numeral (e.g., 1, 1a, 1b). Such shorthand notations are used for purposes of convenience only and should not be construed to limit the disclosure in any way unless expressly stated to the contrary.

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” may be employed to describe elements and components of embodiments disclosed herein. This is done merely for convenience and “a” and “an” are intended to include “one” or “at least one,” and the singular also includes the plural unless it is obvious that it is meant otherwise.

Finally, as used herein, any reference to “one embodiment” or “some embodiments” means that a particular element, feature, structure, or characteristic described in connection with the embodiment is included in at least one embodiment disclosed herein. The appearances of the phrase “in some embodiments” in various places in the specification are not necessarily all referring to the same embodiment, and embodiments may include one or more of the features expressly described or inherently present herein, or any combination or sub-combination of two or more such features, along with any other features which may not necessarily be expressly described or inherently present in the instant disclosure.

Reference will now be made in detail to the subject matter disclosed, which is illustrated in the accompanying drawings. Embodiments of the present disclosure are directed to systems and methods for multi-layer constraint tuning (MLCT) for controlled large language model (LLM) inference. The multi-layer constraint tuning architecture transforms structured input, controls a constraint-based inference, constructs an execution state, and reduces raw data exposure during model execution. The multi-layer constraint tuning architecture transforms the input data into a constrained inference execution state prior to model execution. The multi-layer constraint tuning architecture operates independently of modifications to model weights, enforces constraint-consistent inference behavior, and produces domain-consistent outputs.

Embodiments of the present disclosure are directed to an enhanced artificial intelligence (AI) system for pre- and post-operative care. The system may enhance the quality, accessibility, and efficiency of healthcare by leveraging artificial intelligence to deliver personalized patient care and adaptive medical staff training. By integrating advanced AI algorithms, real-time monitoring, and conversational systems, the system may empower patients, healthcare delivery, and improve patient-provider communication. The system may provide patients with comprehensive, understandable, and actionable guidance before and after medical procedures. The system may enable continuous support for symptom management, discharge instruction interpretation, and recovery optimization. The system may enhance efficiency in performing tasks, such as administrative workflows, symptom triage, and documentation. The system may reduce errors and improve outcomes through predictive analytics and early detection of potential complications. The system may bridge the gap between patients and healthcare providers with intuitive, AI-powered communication tools. The system may ensure patients feel informed, engaged, and supported throughout their care journey.

Embodiments of the present disclosure are also directed to an artificial intelligence (AI) system for dynamic food and wine pairing based on taste profiling and contextual factors. The system leverages a large language model to deliver highly personalized, scientifically grounded, and context-aware recommendations. By combining individual taste profiling, dynamic contextual analysis, and a database of flavor compositions, the large language model empowers consumers, chefs, and sommeliers to make informed and precise pairing decisions. The large language model may enhance the enjoyment of food and wine, bridge cultural and culinary diversity, and democratize expert-level pairing expertise for a global audience.

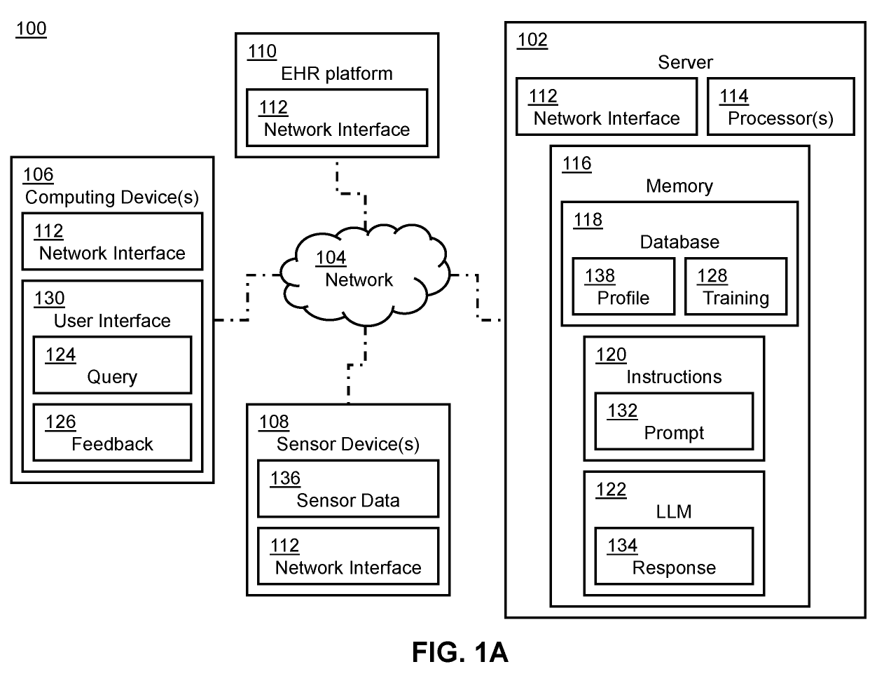

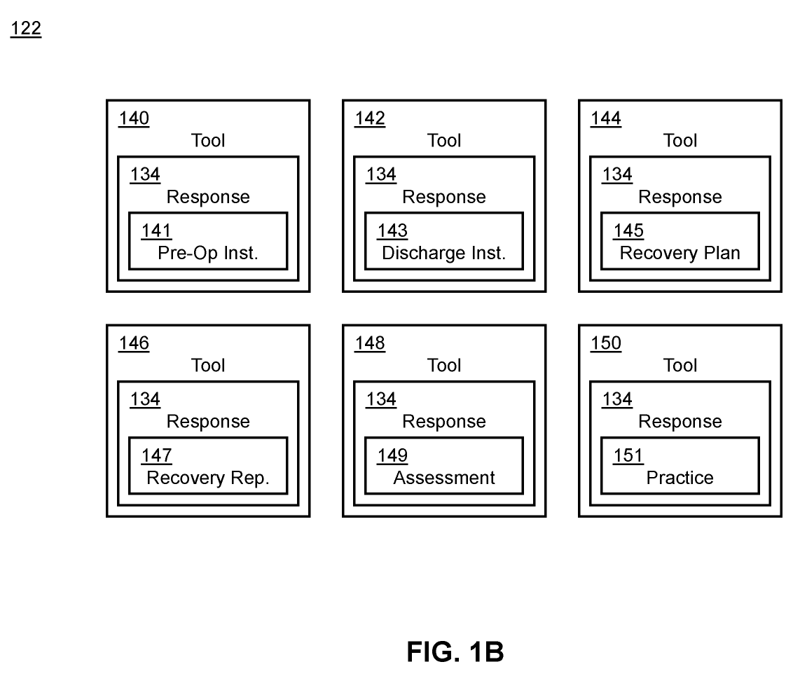

FIG. 1A-1B depicts a system 100, in accordance with one or more embodiments of the present disclosure. The system 100 may be an enhanced artificial intelligence system. The system 100 may be used for various applications, such as, but not limited to, patient care (e.g., pre-operative care, post-operative care, pediatric care, orthopedic recovery), medical staff training, and the like. The system 100 may include various physical components, software integrations, and interfaces. For example, the system 100 may include a server 102, a network 104, computing devices 106, sensor devices 108, and/or an electronic health record platform 110 (EHR platform).

The server 102 may be a cloud-based architecture. For instance, the server 102 may be a remote server, a hosted server, and/or a cloud computing platform, including, but not limited to, Amazon Web Services (e.g., Amazon EC2, and the like), Azure, Google Cloud, or the like. In this regard, the system 100 may include a software as a service (SaaS) configuration, in which various functions or steps of the present disclosure are carried out by the server 102. The server 102 may support large-scale processing and accessibility.

The network 104 may communicatively connect any of the various components of the system 100. For example, the network 104 may communicatively couple the server 102, the computing devices 106, the sensor devices 108, and/or the electronic health record platform 110.

The network 104 may include any network known in the art. The network 104 may use any communication protocols known in the art, including, but not limited to, GSM, GPRS, CDMA, EV-DO, EDGE, WiMAX, 3G, 4G, 4G LTE, 5G, WiFi protocols, radio frequency (RF), LoRa, and the like. The network 104 may also include any wireline communication protocol (e.g., DSL-based interconnection, cable-based interconnection, and the like). Interactions between the components may be determined based on one or more characteristics, including, but not limited to, IP addresses, MAC addresses, and the like. The network 104 may use any suitable network topology. For example, the components of the system 100 may communicatively connect directly with the network 104 in a star topology, may communicate with the network through the computing devices 106 in a mesh topology, or the like.

The server 102, the computing devices 106, the sensor devices 108, and/or the electronic health record platform 110 may include network interfaces 112. The network interfaces 112 may include any suitable network interface for interfacing with the network 104, such as, but not limited to, a wired or a wireless network interface. The network interfaces 112 may include mechanical, electrical, or signaling circuitry for communicating data to and from the network 104 and subsequently to and from the server 102, the computing devices 106, the sensor devices 108, and/or the electronic health record platform 110. The network interfaces 112 may include a wireline connection (e.g., copper wire, fiber optic cable, and the like) or a wireless connection (e.g., RF coupling, IR coupling, WiFi, WiMax, Bluetooth, 3G, 4G, 4G LTE, 5G, and the like). The server 102, the computing devices 106, the sensor devices 108, and/or the electronic health record platform 110 may be configured to receive various input data and transmit various output data to and from the network interfaces 112. The server 102, the computing devices 106, the sensor devices 108, and/or the electronic health record platform 110 may be configured to execute one or more application programming interfaces (APIs) for transmitting and receiving the input data and the output data.

The computing devices 106 and/or the sensor devices 108 may be edge devices in the network 104 for data input, monitoring, and/or data output.

The computing devices 106 may be smartphones, tablets, computers, desktops, laptops, workstations, smart watches, wearable headsets (e.g., augmented reality headsets, virtual reality headsets, smart glasses), or the like. The computing devices 106 may be used by one or more users, such as, but not limited to, patients (e.g., patient computing devices) and/or healthcare providers (e.g., provider computing devices).

The computing devices 106 may include a user interface 130. The user interface 130 may include a display used to display data of the system 100 to a user. The display of the user interface 130 may include any display known in the art. For example, the display may include, but is not limited to, a liquid crystal display (LCD), an organic light-emitting diode (OLED) based display, or a CRT display. Those skilled in the art should recognize that any display device capable of integration with a user interface 130 is suitable for implementation in the present disclosure. In embodiments, a user may input selections and/or instructions responsive to data displayed to the user via the user interface 130.

The user interface 130 may generate the query 124, the feedback 126, and the like. The user interface 130 may generate the query 124 and/or the feedback 126 based on an input received from a user, such as a patient and/or a healthcare provider.

The sensor devices 108 may be wearable sensor devices, smartwatches, fitness trackers, biosensors, medical internet-of-things (IoT) devices, thermometers, blood pressure monitors, glucose meters, physical medical simulators (e.g., mannequins with sensors), or the like. The sensor devices 108 may collect sensor data 136. The sensor devices 108 may collect the sensor data 136 in real-time or at an interval. The sensor data 136 may be physiological data of a patient. For example, the sensor data 136 may include, but is not limited to, heart rate, oxygen level, temperature, blood pressure, glucose level, or the like.

The server 102 may include one or more components, such as, but not limited to, the network interfaces 112, processors 114, and/or memory 116.

The processors 114 may include any processing unit known in the art. For example, the processors 114 may include a single-core processor, a multi-core processor, a reconfigurable logic device (e.g., FPGAs), a digital signal processor (DSP), a special-purpose logic device (e.g., application-specific integrated circuits (ASICs)), central-processing units (CPUs), graphics processing units (GPUs), tensor-processing units (TPUs), or other integrated formats. Those skilled in the art will recognize that aspects of the embodiments disclosed herein, in whole or in part, can be equivalently implemented in integrated circuits, as one or more computer programs running on one or more computers (e.g., as one or more programs running on one or more computing systems), as one or more programs running on one or more processors (e.g., as one or more programs running on one or more microprocessors), as firmware, or as virtually any combination thereof, and that designing the circuitry and/or writing the code for the software and/or firmware would be well within the skill of one skilled in the art in light of this disclosure. Such hardware, software, and/or firmware implementation may be a design choice based on various cost, efficiency, or other metrics. In this sense, the processors 114 may include any microprocessor-type device configured to execute software algorithms and/or instructions. In general, the term “processor” may be broadly defined to encompass any device having one or more processing elements, which execute program instructions from memory, from firmware, or by hardware-implemented functions. It should be recognized that the steps described throughout the present disclosure may be carried out by the processors 114.

The memory 116 may include any storage medium known in the art. For example, the storage medium may include a non-transitory memory medium. For instance, the non-transitory memory medium may include, but is not limited to, a read-only memory (ROM), a random-access memory (RAM), a magnetic or optical memory device (e.g., disk), a solid-state drive, and the like. It is further noted that memory may be housed in a common controller housing with the one or more processor(s). For example, the memory and the processor may be housed in a processing unit, or the like. In an alternative embodiment, the memory may be located remotely with respect to the physical location of the processor. In another embodiment, the memory maintains program instructions for causing the processor(s) to carry out the various steps described through the present disclosure. The memory may include an operating system, program instructions, permission files, and the like, as will be described further herein.

The memory 116 may maintain a database 118, program instructions 120, a large language model 122, and the like. The processors 114 may execute the program instructions 120. The large language model 122 may include modules for natural language processing (NLP), predictive analytics, and the like. The processors 114 may train and/or execute the large language model 122.

The server 102 may manage the database 118. The database 118 may be a secure, Health Insurance Portability and Accountability Act (HIPAA)-compliant database. The database 118 may store various data, such as, but not limited to, the sensor data 136, the patient profile 138, the query 124, the feedback 126, training data 128, and the like. The patient profile 138 may include any of various data regarding a patient, such as, but not limited to, age, surgery type, recovery day, medical conditions, medications, height, weight, identifying information, physiological metrics, medical records, medical history, recovery context, allergies, and the like. The patient profile 138 may be formatted as any suitable data type, such as, but not limited to, a dictionary, an array, or the like. The feedback 126 may include patient feedback, provider feedback, clinical outcomes, and the like. The feedback 126 may indicate the response 134 was a good response or a bad response. The training data 128 may include medical guidelines, research findings, clinical outcomes, and the like.

The electronic health record platform 110 may be any electronic health record platform, such as, but not limited to, a clinical EHR (e.g., Epic, Cerner, or the like), wearable device electronic health records (e.g., Fitbit platform, Apple Health platform), or the like. The electronic health record platform 110 may maintain the patient profile 138.

The server 102 may perform multi-source data fusion. Performing multi-source data fusion may enable the server 102 to perform holistic health monitoring and decision-making. The server 102 may receive and/or fuse any of the various data, such as, the sensor data 136, the patient profile 138, the query 124, the feedback 126, training data 128, and the like, for storage in the database 118 from one or more sources. The server 102 may include connections to the computing devices 106, the sensor devices 108, and/or the electronic health record platform 110 via the network 104. The server 102 may receive the various data from the computing devices 106, the sensor devices 108, and/or the electronic health record platform 110. The server 102 may integrate patient data from multiple sources, such as the computing devices 106, the sensor devices 108, and/or the electronic health record platform 110, leading to complete care and training insights. The server 102 may integrate the data in real-time. For example, the server 102 may receive the sensor data 136 from the sensor devices 108. By way of another example, the server 102 may receive the patient profile 138 from the computing devices 106 and/or the electronic health record platform 110. By way of another example, the server 102 may receive the query 124 and/or the feedback 126 from the computing devices 106. Thus, the server 102 may include real-time inputs from patients, medical staff, and external systems. Patient-specific data may be collected from multiple sources, including wearables and internet-of-things (IoT) devices (e.g., heart rate monitors, glucose meters), the electronic health record platform 110 for medical history and procedural details, real-time user inputs through mobile apps or web portals, and the like. The data may be securely transmitted to the server 102 for processing and integration into the patient profile 138.

The computing devices 106 may include an application or web portal for accessing one or more features of the server 102, such as, but not limited to, accessing the large language model 122, generating recovery plans, viewing educational tools, viewing recommendations, accessing training modules, and the like. The application may be a patient-facing application that may provide interactive recovery tools, discharge paperwork guidance, and symptom monitoring features. The web portions may be accessible interfaces for medical staff to view patient analytics, access training modules, and track performance.

The large language model 122 may also be referred to as a chatbot, an artificial-intelligence (AI)-powered chatbot, a conversational AI, a virtual assistant, or the like. The large language model 122 may be a neural network, such as, but not limited to, a transformer model (e.g., Generative Pre-Trained Transformer (GPT), Bidirectional Encoder Representations from Transformers (BERT)) or the like. The large language model 122 may be a context-aware conversational artificial intelligence.

The query 124 may include a question or concern from the user, such as a patient and/or a healthcare provider. For example, the query 124 may be a patient question with a specific symptom or concern. By way of another example, the query 124 may be a request to simplify discharge instructions. By way of another example, the query 124 may be a request to provide medical training.

The server 102 may construct the prompt 132. The prompt 132 may be a context-rich prompt. The prompt 132 may be a structured prompt for the large language model 122. The prompt 132 may specify an engine of the large language model 122, tokens for the response 134, a randomness (e.g., temperature) of the response 134, and the like.

The server 102 may construct the prompt 132 based on the query 124, the feedback 126, the sensor data 136, and/or the patient profile 138. The program instructions 120 may be executed by the processors 114 to construct the prompt 132. The prompt 132 may instruct the large language model 122 to generate the response 134 based on the query 124, the feedback 126, the sensor data 136, and/or the patient profile 138. For example, the prompt 132 may be of the form: “You are an AI-powered virtual health assistant specializing in pre- and post-operative care. Consider the patient's medical history, surgery type, and current recovery stage to provide a clear, personalized, and actionable recommendation.” The query 124, the feedback 126, the sensor data 136, and/or the patient profile 138 may be included in (e.g., prepended to and/or appended to) the prompt 132.

The server 102 may query the large language model 122 using the prompt 132 to generate the response 134. The large language model 122 may generate the response 134 based on the prompt 132. The large language model 122 may process the prompt 132 using natural-language processing to generate the response 134.

The large language model 122 may generate the response 134 based on the patient profile 138 and the query 124 in the prompt 132. The response 134 may provide personalized recovery advice with contextual understanding based on the patient profile 138 and the query 124. The response 134 may be adapted to individual patient needs or medical staff competencies based on the patient profile 138 and the query 124. The response 134 may adapt dynamically to real-time inputs or evolving circumstances as indicated by the patient profile 138 and the query 124. The response 134 may be tuned based on individual user profiles, such as health history, language preferences, and typical recovery patterns. The response 134 may include actionable advice, such as, but not limited to, exercises, medication guidance, when to escalate care, and the like. The large language model 122 may combine the patient-reported data, wearable inputs, and clinical records to generate actionable insights using the response 134. The response 134 may improve decision-making and standardize care quality.

The computing devices 106 may receive the response 134 from the server 102 and display the response 134. The user interface 130 may display the response 134. The response 134 may be displayed by the user interface 130 through an application, portals, integrated systems, or the like. The response 134 may be displayed to the user, such as the patient and/or healthcare provider.

The large language model 122 may be used for various purposes. For example, the large language model 122 may be a pre-operative tool 140, a patient-discharge tool 142, a dynamic-recovery-plan-generator tool 144, a progress-tracking tool 146, a symptom-management tool 148, a medical-training-and-simulation tool 150, and the like. The large language model 122 may be any and/or all of the tools. The large language model 122 may be configured as the tool based on the way the large language model 122 is trained, the contents of the query 124, and/or the way the program instructions 120 generate the prompt 132. The tools may address challenges in surgical care, including patient understanding, symptom management, recovery optimization, and continuous support. The response 134 may assist patients with pre- and post-operative care. The response 134 may provide personalized and easily accessible support before and after surgery or other procedures. The large language model 122 may be a scalable and cost-effective solution for hospitals and clinics to enhance patient care. The large language model 122 may be a holistic tool for enhancing surgical outcomes and patient satisfaction. The system 100 can provide pre- and post-operative care guidance by integrating the patient profile 138, the query 124, and/or the feedback 126 with the large language model 122. The large language model 122 may answer patient questions and assist medical staff with reference queries. The large language model 122 may answer questions, provide symptom assessments, and offer care recommendations in real time. The large language model 122 may engage patients in a user-friendly, accessible way. The large language model 122 may provide personalized patient care, symptom analysis, and staff training. The system 100 may be scalable across healthcare needs. The system 100 may be versatile enough to address a wide range of scenarios, from pre- and post-operative care to training for emergency medical procedures.

In embodiments, the large language model 122 may be the pre-operative tool 140. The pre-operative tool 140 may generate pre-operative instructions 141 (Pre-Op instructions). The response 134 may include the pre-operative instructions 141. The pre-operative instructions 141 may provide procedure education. For example, the pre-operative instructions 141 may provide detailed, accessible explanations of surgical procedures, risks, benefits, and expected outcomes, which may be customized based on the patient profile 138 and medical history. The large language model 122 may tailor the pre-operative instructions 141 to individual patient needs and medical records. The pre-operative instructions 141 may provide pre-surgical preparation guidance, offering personalized preparation checklists (e.g., fasting, medication adjustments, hygiene protocols). The pre-operative instructions 141 may provide reminders and alerts, such as stopping certain medications or arrival times. The pre-operative instructions 141 may provide automated reminders for preparation tasks, like fasting or stopping medications. The pre-operative instructions 141 may provide symptom pre-screening by assessing symptoms or concerns prior to surgery, identifying red flags that may require rescheduling or additional tests. The pre-operative instructions 141 may educate patients about upcoming procedures, risks, and preparation steps, including educational tools.

In embodiments, the large language model 122 may be the patient-discharge tool 142. The patient profile 138 may include discharge instructions 143. The large language model 122 may generate the response 134 with the discharge instructions 143. The large language model 122 may tailor the discharge instructions 143 to the patient profile 138. The discharge instructions 143 may include patient-specific responses for medication, symptoms, and recovery steps. The discharge instructions 143 may include educational materials, such as pamphlets, brochures, or verbal instructions from staff regarding surgical procedures, symptoms, and recovery plans taken from the patient profile 138. The large language model 122 may simplify the discharge instructions 143. The large language model 122 may include natural language processing (NLP) that interprets and simplifies the discharge instructions 143 when generating the response 134. The large language model 122 may simplify complex medical instructions into layman's terms. The large language model 122 may interpret the discharge instructions 143, translating medical language into simple, actionable steps via the response 134. The large language model 122 may use natural language processing to translate the discharge instructions 143 into easy-to-understand, patient-friendly instructions.

In embodiments, the large language model 122 may be the dynamic-recovery-plan-generator tool 144. The dynamic-recovery-plan-generator tool 144 may generate a recovery plan 145. The response 134 may include the recovery plan 145. The recovery plan 145 may include exercise regimens, dietary recommendations, mobility precautions, and the like. The large language model 122 may tailor the recovery plan 145 to the patient profile 138. The recovery plan 145 may be personalized to individual patient needs or conditions. The large language model 122 may customize and adjust the recovery plan 145 based on real-time feedback and wearable device data. The recovery plan 145 may be personalized and tailored based on patient-specific factors, such as age, comorbidities, and surgery type. The recovery plan 145 may be tailored to patient-specific data, including surgical history, health conditions, and real-time monitoring from wearables and IoT devices. The recovery plan 145 may provide interactive exercise and rehabilitation guidance. The recovery plan 145 may include post-operative exercise plans, which may suggest specific exercises (e.g., stretching, mobility routines) based on the procedure and patient’s condition. The recovery plan 145 may include video demonstrations with step-by-step instructions. The large language model 122 may generate the recovery plan 145, which may adjust dynamically based on real-time patient feedback and sensor data from wearable devices. The recovery plan 145 may include visual recovery tools, reminders, and tailored instructions to encourage adherence to care plans. The recovery plan 145 may include visual recovery tools, like progress trackers, milestone heatmaps, and exercise demonstrations, to enhance patient engagement. The recovery plan 145 may provide interactive features (e.g., exercise demonstrations, progress trackers) that may keep recovery plans engaging and actionable. The recovery plan 145 may provide motivational tips or adjust plans to accommodate patient limitations. The recovery plan 145 may improve patient understanding based on easy-to-understand information, reducing confusion and anxiety. The large language model 122 may improve recovery optimization by tailoring the recovery plan 145 to improve compliance and outcomes. The large language model 122 may perform context-aware adjustments on the recovery plan 145. For example, the large language model 122 may adapt the recovery plan 145 based on external factors, such as weather, patient environment, or regional medical practices. The recovery plan 145 may include step-by-step guides for tasks, such as medication management and wound care.

In embodiments, the large language model 122 may be the progress-tracking tool 146. The progress-tracking tool 146 may generate a recovery report 147. The response 134 may include the recovery report 147. The server 102 may store the user interactions, analyze trends over time, and generate the recovery report 147 using the large language model 122. The recovery report 147 may be tracked to ensure compliance with the recovery plan 145. The recovery report 147 may provide progress tracking by providing daily or weekly progress check-ins via a mobile app, helping patients track recovery milestones. The recovery report 147 may generate alerts if the progress deviates from expected recovery patterns, triggering early interventions. The recovery report 147 may ensure patients follow tailored recovery plans that include exercise routines, dietary recommendations, and wound care instructions. The recovery report 147 may track recovery milestones and provide alerts for follow-up appointments. The recovery report 147 may improve patient compliance with preparation and recovery protocols. The recovery report 147 may provide compliance tracking that may monitor adherence to prescribed exercises using wearable devices or patient self-reports. The recovery report 147 may include visual recovery tools and milestones, which may help patients track progress against personalized recovery benchmarks. The recovery report 147 may provide alerts for follow-up appointments or when recovery deviates from expected patterns. Tracking the recovery progress in real-time may enable flagging deviations from expected recovery milestones. The recovery report 147 may ensure timely interventions by alerting medical staff to deviations from the recovery plan 145.

In embodiments, the large language model 122 may be the symptom-management tool 148. The symptom-management tool 148 may generate a symptom assessment 149. The response 134 may include the symptom assessment 149. The symptom-management tool 148 may provide symptom triage and monitoring. The symptom-management tool 148 may be used for pre-operative and/or post-operative symptom management. The large language model 122 may tailor the symptom assessment 149 to the patient profile 138. The large language model 122 may triage the query 124 and generate the symptom assessment 149 by combining patient-reported symptoms with medical guidelines. The query 124 may allow patients to describe symptoms or concerns (e.g., pain levels, swelling, fever), provide questions about symptoms, the discharge instructions 143, recovery concerns, or the like. The large language model 122 may triage the query 124 and generate the response 134 with an action, such as contacting a physician, contacting a healthcare provider, taking prescribed medication, or performing self-care steps. The large language model 122 may integrate patient-reported data with recovery timelines in the patient profile 138 to generate the symptom assessment 149 with real-time recommendations. The large language model 122 may perform real-time symptom assessment based on the patient profile 138 when generating the symptom assessment 149 to distinguish between normal recovery and potential complications. The large language model 122 may enable constant monitoring and triage by analyzing the patient profile 138, improving response times for potential complications. The symptom assessment 149 may enable early detection of complications through real-time monitoring and symptom triage of the patient profile 138. The server 102 may integrate with wearable devices to pull real-time patient data for real-time health tracking. The symptom assessment 149 may perform triage escalation by adding severity scoring for symptoms to trigger alerts for doctors and escalate concerns to healthcare providers based on severity. The symptom assessment 149 may provide alerts and insights about patient progress or risks. Thus, the symptom assessment 149 may provide real-time monitoring and feedback by continuously monitoring patient health data and recovery progress. The symptom assessment 149 may guide patients in recognizing normal recovery symptoms versus complications. The symptom assessment 149 may provide continuous support by ensuring patients feel supported and connected to care teams throughout the recovery process. The symptom assessment 149 may provide clear, actionable answers about symptoms. The symptom assessment 149 may enable patients to ask questions about symptoms, medication, dietary restrictions, or follow-up schedules at any time. The symptom assessment 149 may improve decision-making through real-time insights and patient care recommendations. The large language model 122 may offer a searchable interface for patients to ask questions via the query 124 about their post-operative requirements (e.g., medication schedules, wound care) and provide the symptom assessment 149 answering the query 124. The interactive search feature allows patients to clarify specific terms or steps. The symptom assessment 149 may provide preventative care and early intervention. The symptom assessment 149 may predict and flag potential complications before escalation, leading to better outcomes and reduced readmissions. The symptom assessment 149 may predict potential complications or outcomes using predictive analytics based on the patient profile 138. The proactive health monitoring may provide predictive analytics which may detect complications early, enabling timely interventions and reducing hospital readmissions. The symptom assessment 149 may be used by medical staff during patient interactions, including treatment options and risk assessments. The symptom assessment 149 may predict potential complications or adverse outcomes based on historical and real-time data, allowing proactive interventions.

An example of providing symptom management is now provided. The patient profile 138 may be of the form: “age: 45, surgery type: Knee Replacement, recovery day: 7, medical conditions: [Hypertension, Type 2 Diabetes], and medications: [Metformin, Lisinopril]”. The query 124 may be of the form: “My knee feels swollen and stiff today. Is this normal, and what can I do to reduce swelling?”. The server 102 may construct the prompt 132 with the patient profile 138 and the query 124. The large language model 122 may generate the response 134 of the form: “Swelling and stiffness are common on Day 7 after a knee replacement. To reduce swelling: elevate your leg above heart level when resting, apply an ice pack wrapped in a cloth for 15-20 minutes every 2-3 hours, continue your prescribed physical therapy exercises to improve mobility, and take your pain and anti-inflammatory medications as directed. If swelling is severe or accompanied by redness, warmth, or fever, contact your healthcare provider immediately.”

In embodiments, the large language model 122 may be the medical-training-and-simulation tool 150. The medical-training-and-simulation tool 150 may generate a clinical practice 151. The response 134 may include the clinical practice 151. The computing devices 106 and/or the sensor devices 108 may be connected to the server 102 for adaptive/immersive medical training sessions. The clinical practice 151 may simulate clinical challenges, be adaptive, provide skill reinforcement, provide team-based training, provide AR/VR training, or the like.

In embodiments, the clinical practice 151 may simulate clinical challenges. The clinical practice 151 may include scenarios that simulate diverse clinical challenges, from routine care to high-pressure emergencies. The clinical practice 151 may provide real-time feedback and analytics with detailed insights into trainee performance, highlighting areas for improvement and reinforcing strengths. The clinical practice 151 may improve medical staff performance and ensure staff are well-prepared for diverse medical scenarios, reducing errors in patient care.

In embodiments, the clinical practice 151 may be adaptive. The large language model 122 may adapt the clinical practice 151 to individual competencies and learning needs. The clinical practice 151 may provide dynamic content adapted to individual learning speeds or areas of weakness. The clinical practice 151 may include adaptive medical simulations with training for medical staff that may adapt to individual performance or evolving medical practices. The clinical practice 151 may provide scenario-specific training for medical staff, in which training simulations are dynamically adjusted to match the complexity level required by the trainee, as indicated by the prompt 132. The large language model 122 may tailor the clinical practice 151 for medical staff based on skill gaps and performance data. The clinical practice 151 may provide training simulation and skill development with adaptive simulations that guide medical staff through realistic scenarios, adjusting difficulty based on their performance. The clinical practice 151 may provide medical staff support and training which enhances competency through adaptive learning modules and real-time feedback during simulations. The clinical practice 151 may reduce training costs and ensure consistent skill development across all levels of staff. The clinical practice 151 may provide training by adaptive simulations that mimic real-life medical scenarios, such as emergency response or rare case management. The large language model 122 may adapt the clinical practice 151 by adjusting training scenarios in real-time based on trainee performance and creating a personalized learning experience. The large language model 122 may ensure simulations are tailored to the specific medical expertise, experience level, and specialty of the staff. The clinical practice 151 may adjust simulations and training paths based on individual performance, ensuring personalized skill development. Staff may train more efficiently by focusing on areas of weakness identified by the clinical practice 151.

In embodiments, the clinical practice 151 may provide skill reinforcement. The large language model 122 may provide knowledge retention and skill reinforcement with spaced repetition algorithms that optimize knowledge retention, ensuring staff maintain proficiency in critical areas. The clinical practice 151 may provide detailed performance analytics which provide actionable insights to improve training outcomes. The clinical practice 151 may improve knowledge retention through personalized learning paths and spaced repetition techniques. The large language model 122 may include spaced repetition algorithms which optimize long-term knowledge retention for medical concepts. The large language model 122 may provide knowledge retention optimization with spaced repetition algorithms that enhance long-term retention of critical knowledge, ensuring continuous skill development.

In embodiments, the clinical practice 151 may provide team-based training. The clinical practice 151 may include team-based scenario training which may enable interdisciplinary simulations for teams to practice collaboration in realistic clinical scenarios. The clinical practice 151 may include scenarios that may adapt based on team interactions and decision-making effectiveness. The clinical practice 151 may include interdisciplinary simulations to prepare staff for real-world collaborative scenarios, improving teamwork and decision-making under pressure. The team-based training may allow collaboration with interdisciplinary teams using AI-driven case summaries and alerts.

In embodiments, the clinical practice 151 may provide AR/VR training. The large language model 122 may be cost-effective and scalable by reducing the need for physical training resources like mannequins and models by incorporating virtual simulations and AR/VR tools. The clinical practice 151 may be scalable to train large groups or remote teams without the logistical challenges of traditional in-person training. The computing devices 106 may include AR/VR integration for patients and staff which may provide immersive training simulations for medical staff and visual guides for patients (e.g., AR-based wound care tutorials). VR platforms may be used for immersive training simulations integrating AI for adaptation or feedback. For example, a VR-based surgery simulator may replicate procedures and track or analyze user performance.

The large language model 122 may answer the query 124 about procedures, recovery symptoms, discharge instructions, and lifestyle changes using the pre-operative instructions 141, the discharge instructions 143, the recovery plan 145, the recovery report 147, the symptom assessment 149, and the clinical practice 151. The large language model 122 may individualize the pre-operative instructions 141, the discharge instructions 143, the recovery plan 145, the recovery report 147, the symptom assessment 149, and the clinical practice 151 to the patient profile 138, which is unique to each patient and may adapt dynamically to real-time feedback, ensuring care recommendations remain relevant and effective. The large language model 122 generating the pre-operative instructions 141, the discharge instructions 143, the recovery plan 145, the recovery report 147, the symptom assessment 149, and/or the clinical practice 151 may reduce administrative burden by automating tasks like documentation, scheduling, and patient monitoring. The large language model 122 generating the pre-operative instructions 141, the discharge instructions 143, the recovery plan 145, the recovery report 147, the symptom assessment 149, and/or the clinical practice 151 may provide patients with access to personalized information about their pre- or post-operative care through an intuitive mobile app or chatbot. The patients may generate the query 124 about symptoms, recovery requirements, or discharge instructions in real time.

The server 102 may be configured to train the large language model 122. The server 102 may train the large language model 122 by dynamic dataset updates, self-enriching models, long-term learning and improvement, reinforcement learning, a hybrid human-AI review cycle, or the like. The server 102 may train the large language model 122 using the training data 128. For example, the large language model 122 may incorporate new medical guidelines, research findings, and clinical outcomes into the training data 128, ensuring the large language model 122 reflects the latest standards of care. Thus, the large language model 122 may be updated with the latest medical research and guidelines, staying up-to-date with medical advancements. By way of another example, the large language model 122 may be trained with the feedback 126. The large language model 122 may use the feedback 126 to provide contextual adjustments when updating the response 134. The feedback 126 may be processed in real-time to fine-tune the generation of the response 134 for greater accuracy. For instance, the feedback 126 may be used in a patient feedback loop. Patients may rate the relevance and helpfulness of the response 134. By way of another instance, the feedback 126 may be used in a medical staff feedback loop. Staff may review and evaluate the response 134, ensuring alignment with real-world requirements. The large language model 122 may incorporate patient feedback, clinical outcomes, and staff interactions to improve over time. The large language model 122 may be a self-enriching AI model that may improve over time by learning from patient and staff interactions. For instance, the large language model 122 may be trained using reinforcement learning (RL). Successful interactions (e.g., accurate symptom triage or effective training sessions) may be rewarded using reinforcement learning in the large language model 122 to reinforce beneficial behaviors and minimize negative behaviors. The server 102 may also perform a hybrid human-AI review cycle where human experts validate the response 134 generated by the server 102. The response 134 may be validated to retrain and refine the large language model 122, improving long-term reliability and precision.

The large language model 122 may improve accessibility for patients and/or healthcare providers. For example, the large language model 122 may be accessible from remote or underserved areas via the network 104. The large language model 122 may democratize access to expert knowledge by providing scalable, cost-effective solutions that make expert-level medical guidance and training accessible to a broader audience, including underserved populations. The large language model 122 may include a scalable infrastructure that enables deployment across diverse healthcare settings, including remote and underserved areas. By way of another example, the large language model 122 may be accessible at any time. The system 100 may provide 24/7 support such that patients can access the system 100 anytime, reducing anxiety and reliance on limited office hours or human availability. The system 100 may offer round-the-clock support for common post-op concerns, increasing patient confidence and compliance. By way of another example, the system 100 may include a scalable deployment infrastructure. The server 102 may support usage across a wide range of healthcare settings, from large hospitals to small clinics and remote care facilities. The system 100 may scale to serve large hospitals, outpatient clinics, and remote care facilities.

The large language model 122 may be multilingual and/or include accessible features. The large language model 122 may support one or more languages. The large language model 122 may support natural language interaction across multiple languages. For example, the large language model 122 may support multiple languages. The large language model 122 may offer accessibility features, such as, but not limited to, voice interaction, voice commands, text-to-speech, and/or simplified user interfaces for patients with disabilities. The large language model 122 may ensure inclusivity for diverse populations by being multilingual and/or including the accessible features. The multilingual and accessibility features may ensure inclusivity for patients with language barriers or disabilities.

The system 100 may be beneficial for several reasons. For example, the system 100 may improve operational efficiency by automating routine tasks, such as symptom triage, documentation, and discharge planning, reducing the administrative burden on healthcare providers. The system 100 may free up medical staff to focus on patient care by handling repetitive tasks and streamlining workflows. By way of another example, the system 100 may provide data-driven decision making. Multimodal data may be combined from wearables, the electronic health record platform 110, and patient inputs to provide actionable insights for better decision-making. The system 100 may provide real-time decision support that improves diagnosis accuracy and treatment planning. By way of another example, the system 100 may improve patient outcomes. The system 100 may enable early detection of complications and adherence to personalized care plans, which may lead to faster recoveries and reduced readmissions. The monitoring may ensure that deviations in recovery are addressed promptly, minimizing long-term risks.

The system 100 may integrate conversational artificial intelligence, real-time monitoring, and personalized recovery plans to guide patients through the surgical process and recovery phase, addressing common gaps in patient understanding and compliance. The system 100 may provide an unparalleled combination of personalization, efficiency, and scalability, making it a transformative solution for patient care and medical staff training. The system 100 may integrate real-time data, adapt to user needs, and automate complex tasks, which sets it apart from prior solutions, ultimately improving healthcare outcomes and operational effectiveness. Tuning the large language model 122 may create a continuously improving, user-centered healthcare solution. The system 100 may revolutionize patient care and medical training by combining cutting-edge AI, real-time data, and user-centric interfaces, making healthcare more effective, accessible, and personalized. The system 100 may bridge the gap between patients and healthcare providers by offering a seamless platform for sharing information, updates, and feedback. The system 100 may encourage patient engagement and foster trust through transparency and accessible communication tools. The system 100 may reduce human error in symptom triage, documentation, and care plan development. The system 100 may ensure consistency and accuracy in medical guidance, training, and monitoring. The system 100 may prioritize personalization, adaptability, and efficiency while ensuring broad accessibility and scalability. The system 100 may provide event-specific adaptability. The system 100 may be configurable for specific healthcare scenarios, such as emergency response, post-surgical care, or chronic disease management. The system 100 may enhance the quality of care with scalable, data-driven systems that optimize patient outcomes. The system 100 may improve patient understanding of care procedures and recovery expectations. The system 100 may provide predictive analytics for risk management.

The system 100 may execute any of various healthcare processes, such as appointment scheduling, follow-up reminders, and symptom triage. The system 100 may automate repetitive tasks and streamline workflows, saving time and reducing costs. The system 100 may automate routine tasks, such as patient monitoring, symptom triage, and discharge paperwork interpretation. The system 100 may provide automated clinical documentation. The large language model 122 may transcribe and structure clinical notes from patient-provider interactions, reducing the administrative burden on healthcare staff.

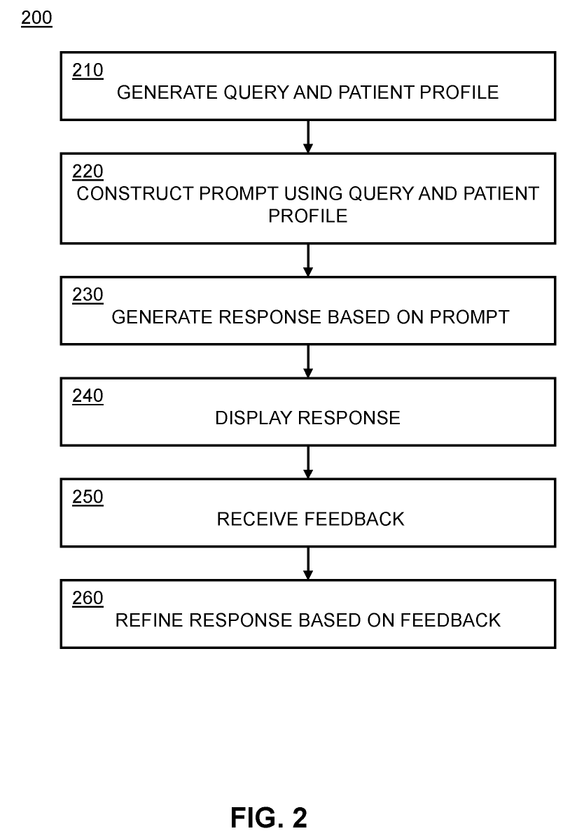

FIG. 2 depicts a flow diagram of a method 200, in accordance with one or more embodiments of the present disclosure. The method 200 may be a multi-layered constraint tuning (MLCT) method. The method 200 may ensure personalized, medically relevant, and AI-driven post-operative guidance via the response 134 for improved patient recovery. The method 200 may enhance the ability of the large language model 122 to personalize the response 134 through continuous, targeted optimization. The method 200 may improve the accuracy of the response 134 and adapt the response to evolving medical standards and user needs. The method 200 may ensure the large language model 122 remains precise, contextually aware, and up-to-date. The method 200 may ensure that the response 134 is contextually accurate and personalized. The method 200 may ensure precise, patient-specific responses and personalized training modules. The method 200 may be implemented by program instructions executable by the processors 114. The execution by the processors 114 may not require significant time from medical staff and may lead to efficiencies. The embodiments and enabling technologies described previously herein in the context of the system 100 should be interpreted to extend to method 200. It is further noted, however, that the method is not limited to the architecture of the system 100.

In a step 210, the user interface 130 may generate the query 124 and/or the patient profile 138. For example, the patient may input the query 124 and/or the patient profile 138 into the user interface 130.

In a step 220, the program instructions 120 may construct the prompt 132 using the query 124 and/or the patient profile 138.

In a step 230, the large language model 122 may generate the response 134 based on the prompt 132. The response 134 may include personalized guidance based on the provided information, addressing the patient's question or concern.

In a step 240, the user interface 130 may display the response 134. For example, the user interface 130 may display the pre-operative instructions 141, the discharge instructions 143, the recovery plan 145, the recovery report 147, the symptom assessment 149, the clinical practice 151, and the like.

In a step 250, the user interface 130 may receive the feedback 126. For example, the patient may input the feedback 126 into the user interface 130.

In a step 260, the large language model 122 may refine the response 134 based on the feedback 126. The feedback 126 may be used to refine the response 134, such as updating the pre-operative instructions 141, the discharge instructions 143, the recovery plan 145, the recovery report 147, the symptom assessment 149, the clinical practice 151, and the like. The large language model 122 may analyze patterns in the query 124 and/or the feedback 126 to identify gaps in understanding or engagement, adjusting the response 134 accordingly.

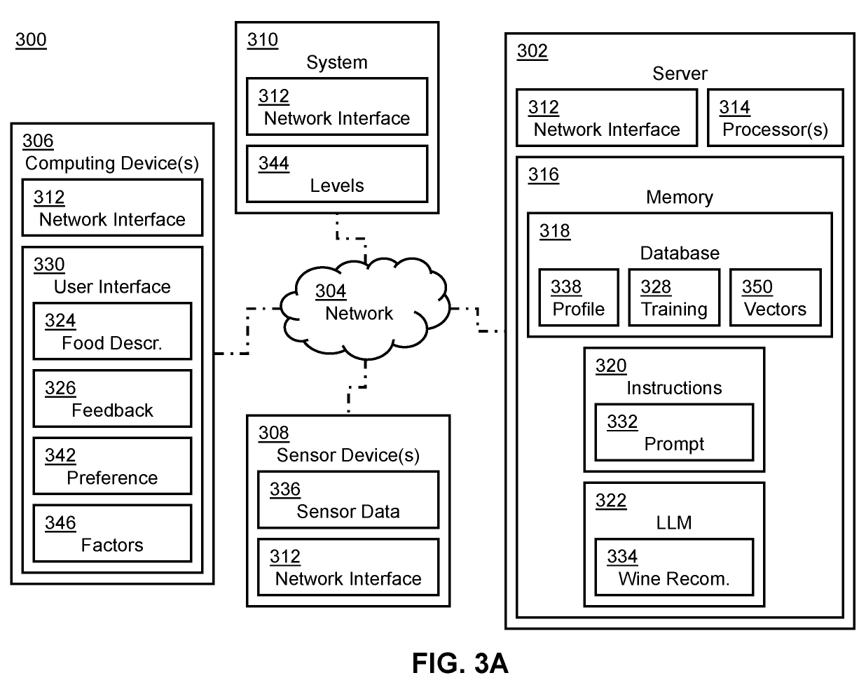

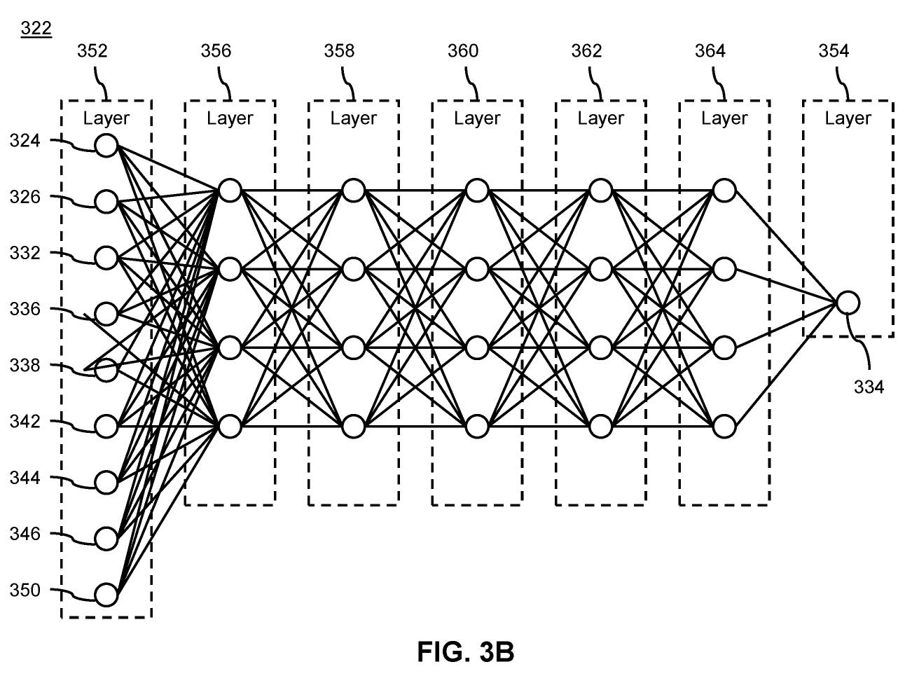

FIG. 3A-3B depicts a system 300, in accordance with one or more embodiments of the present disclosure. The system 300 may be an enhanced artificial intelligence system. The system 300 may be used for dynamic food and wine pairing based on a taste profile 338 and contextual factors 346. The system 300 may include various physical components, software integrations, and interfaces. For example, the system 300 may include a server 302, a network 304, computing devices 306, sensor devices 308, and/or an inventory-tracking system 310. The discussion of the server 102, the network 104, the computing devices 106, and the sensor devices 108 is incorporated herein by reference as to the server 302, the network 304, the computing devices 306, and the sensor devices 308.

The server 302 may be a cloud-based architecture. For instance, the server 302 may be a remote server, a hosted server, and/or cloud computing platform, including, but not limited to, Amazon Web Services™ (e.g., Amazon EC2™, and the like), Azure™, Google Cloud™, or the like. In this regard, the system 300 may include a software as a service (SaaS) configuration, in which various functions or steps of the present disclosure are carried out by the server 302. The server 302 may support large-scale processing and accessibility.

The network 304 may communicatively couple the server 302, the computing devices 306, the sensor devices 308, and/or the inventory-tracking system 310. The network 304 may include any network known in the art. The network 304 may include any communication protocols known in the art, including, but not limited to, GSM, GPRS, CDMA, EV-DO, EDGE, WiMAX, 3G, 4G, 4G LTE, 5G, WiFi protocols, radio frequency (RF), LoRa, and the like. The network 304 may also include any wireline communication protocol (e.g., DSL-based interconnection, cable-based interconnection, and the like). Interactions between the components may be determined based on one or more characteristics, including, but not limited to, IP addresses, MAC addresses, and the like. The network 304 may include any suitable network topology. For example, the server 302, the computing devices 306, the sensor devices 308, and/or the inventory-tracking system 310 may communicatively couple directly with the network 304 in a star topology. By way of another example, the sensor devices 308 may communicate with the network through the computing devices 306 in a mesh topology.

The server 302, the computing devices 306, the sensor devices 308, and/or the inventory-tracking system 310 may include network interfaces 312. The network interfaces 312 may include any suitable network interface for interfacing with the network 304, such as, but not limited to, a wired or a wireless network interface. The network interfaces 312 may include mechanical, electrical, or signaling circuitry for communicating data to and from the network 304 and subsequently to and from the server 302, the computing devices 306, the sensor devices 308, and/or the inventory-tracking system 310. The network interfaces 312 may include a wireline connection (e.g., copper wire, fiber optic cable, and the like) or a wireless connection (e.g., RF coupling, IR coupling, WiFi, WiMax, Bluetooth, 3G, 4G, 4G LTE, 5G, and the like). The server 302, the computing devices 306, the sensor devices 308, and/or the inventory-tracking system 310 may be configured to receive various input data and transmit various output data to and from the network interfaces 312. The server 302, the computing devices 306, the sensor devices 308, and/or the inventory-tracking system 310 may be configured to execute one or more application programming interfaces (APIs) for transmitting and receiving the input data and the output data.

The computing devices 306 and/or the sensor devices 308 may be edge devices in the network 304 for data input, monitoring, and/or data output.

The computing devices 306 may be point-of-sale (POS) systems, kiosks, embedded systems, smartphones, tablets, computers, desktops, laptops, workstations, smart watches, wearable headsets (e.g., augmented reality headsets, virtual reality headsets, smart glasses), smart assistants (e.g., Amazon Alexa, Google Assistant), or the like. The computing devices 306 may be used by one or more users, such as, but not limited to, consumers (e.g., food and wine consumers) and/or providers (e.g., food and wine providers, restaurants, grocery stores, wine stores, and the like). The computing devices 306 may include compact devices, such as portable smartphones or tablets to access pairing suggestions during grocery shopping or meal preparation. The computing devices 306 may include voice assistants which may access pairing suggestions via hands-free voice commands. The computing devices 306 may include tabletop kiosks, such as standalone touch-screen devices in restaurants or wine shops for customer interaction. The computing devices 306 may include back-end systems, such as staff-facing dashboards for sommeliers or store managers to view pairing insights and manage inventory connections. The computing devices 306 may include platforms with mobile applications to provide consumers with input for dish descriptions, taste preferences, and contextual details. The computing devices 306 may include web portals which may be accessible via web browsers for restaurants, sommeliers, or wine retailers to manage inventory-specific pairing recommendations.

The computing devices 306 may include a user interface 330. The user interface 330 may include a display used to display data of the system 300 to a user. The display of the user interface 330 may include any display known in the art. For example, the display may include, but is not limited to, a liquid crystal display (LCD), an organic light-emitting diode (OLED) based display, or a CRT display. Those skilled in the art should recognize that any display device capable of integration with a user interface 330 is suitable for implementation in the present disclosure. In embodiments, a user may input selections and/or instructions responsive to data displayed to the user via the user interface 330.

The user interface 330 may generate the food description 324, the feedback 326, the user-specific wine preference 342, the contextual factors 346, and the like. The user interface 330 may generate the food description 324, the feedback 326, the user-specific wine preference 342, and/or the contextual factors 346 based on an input received from a user, such as the consumer and/or the providers. Users may interact with the user interface 330 to provide real-time suggestions, allowing for adjustments (e.g., swapping wines or dishes), and collect the feedback 326.

The food description 324 may be a food item that is to be paired with a wine. The food description 324 may include a description of the food item. The food description 324 may include one or more qualities of the food item, such as, but not limited to, a type of meat, a type of sauce, a side dish, a food intensity, and the like. The food description 324 may include a description of a food item to be consumed together with a request to generate the wine recommendation 334 based on the food description 324.

The user-specific wine preference 342 may indicate a like and/or a dislike of one or more classifications of wine. The user-specific wine preference 342 may include any suitable classification of wine, such as, but not limited to, color (e.g., red, white, rosé, amber, and the like), sugar content (e.g., sweetness/dryness), pH (e.g., acidity or tartness), tannin content (e.g., bitterness), alcohol content, vintage, calorie content, carbon-dioxide content (e.g., sparkling wine, non-sparkling wine), place of origin, packaging (e.g., cork, screwcap, and the like), cost, bottle size, and the like. The user-specific wine preference 342 may also indicate favorite ingredients in the wine.

The contextual factors 346 may include one or more contextual factors. For example, the contextual factors 346 may include a temperature, a time of day, a time of year (e.g., month or season), a location (e.g., regional preferences), a mood, a budget constraint, a type of event (e.g., romantic dinner, corporate event, casual lunch, a wedding, a casual dinner, or the like), dietary restrictions, cultural factors (e.g., cuisines, regions, ethnicities, religions, and the like), regional culinary practices, environmental factors, or the like.

The inventory-tracking system 310 may include any suitable inventory-tracking system, such as, but not limited to, an enterprise resource planning (ERP) system, a warehouse management system, an order management system, or the like. The inventory-tracking system 310 may track inventory levels 344. The inventory levels 344 may be levels of inventory of wine that are in stock. The inventory-tracking system 310 may be used by wine providers, such as, restaurants, retailers, personal wine collections, or the like.

The server 302 may include one or more components, such as, but not limited to, the network interfaces 312, processors 314, and/or memory 316.

The processors 314 may include any processing unit known in the art. For example, the processors 314 may include a single-core processor, a multi-core processor, a reconfigurable logic device (e.g., FPGAs), a digital signal processor (DSP), a special-purpose logic device (e.g., application-specific integrated circuit (ASICs)), central processing units (CPUs), graphics processing units (GPUs), tensor-processing units (TPUs), or other integrated formats. Those skilled in the art will recognize that aspects of the embodiments disclosed herein, in whole or in part, can be equivalently implemented in integrated circuits, as one or more computer programs running on one or more computers (e.g., as one or more programs running on one or more computing systems), as one or more programs running on one or more processors (e.g., as one or more programs running on one or more microprocessors), as firmware, or as virtually any combination thereof, and that designing the circuitry and/or writing the code for the software and/or firmware would be well within the skill of one skilled in the art in light of this disclosure. Such hardware, software, and/or firmware implementation may be a design choice based on various cost, efficiency, or other metrics. In this sense, the processors 314 may include any microprocessor-type device configured to execute software algorithms and/or instructions. In general, the term “processor” may be broadly defined to encompass any device having one or more processing elements, which execute program instructions from memory, from firmware, or by hardware-implemented functions. It should be recognized that the steps described throughout the present disclosure may be carried out by the processors 314.

The memory 316 may include any storage medium known in the art. For example, the storage medium may include a non-transitory memory medium. For instance, the non-transitory memory medium may include, but is not limited to, a read-only memory (ROM), a random-access memory (RAM), a magnetic or optical memory device (e.g., disk), a solid-state drive, and the like. It is further noted that memory may be housed in a common controller housing with the one or more processor(s). For example, the memory and the processor may be housed in a processing unit, or the like. In an alternative embodiment, the memory may be located remotely with respect to the physical location of the processor. In another embodiment, the memory maintains program instructions for causing the processor(s) to carry out the various steps described throughout the present disclosure. The memory may include an operating system, program instructions, permission files, and the like, as will be described further herein.

The memory 316 may maintain a database 318, program instructions 320, a large language model 322, and the like. The processors 314 may execute the program instructions 320. The large language model 322 may include modules for natural language processing (NLP), predictive analytics, and the like. The processors 314 may train and/or execute the large language model 322.

The server 302 may manage the database 318. The database 318 may be a food and wine pairing database. The database 318 may store various data, such as, but not limited to, the food description 324, the feedback 326, training data 328, the wine recommendation 334, the sensor data 336, the taste profile 338, the user-specific wine preference 342, the inventory levels 344, the contextual factors 346, flavor vectors 350, and the like. The server 302 may update the database 318. The database 318 may be a self-enriching database which may grow with new data inputs, ensuring up-to-date recommendations. The server 302 may update the database 318 based on user feedback, expert input, and new chemical analyses, ensuring constant evolution. The server 302 may automatically update the database 318 with new sensory data, user preferences, expert insights, and the like. The database 318 may merge qualitative (expert opinions) and quantitative (chemical profiles) data sources.

The taste profile 338 may include any of various data regarding the consumer, such as, but not limited to, the user-specific wine preference 342, the feedback 326, user behavior, and implicit signals (e.g., pairing ratings). The taste profile 338 may be personalized to each user. The taste profile 338 may include historical user preferences or ratings associated with the consumer. The server 302 may dynamically create the taste profile 338. For example, the server 302 may process the user-specific wine preference 342 and the feedback 326 through a machine learning model to generate the taste profile 338. The server 302 may include algorithms for generating the taste profile 338, such as adaptive learning algorithms, clustering algorithms, and the like. The taste profile 338 may identify the user’s preference for specific classifications of wines. The taste profile 338 may be formatted as any suitable data type, such as, but not limited to, a dictionary, an array, or the like. The taste profile 338 may be adapted based on the feedback 326 and behavioral patterns. The taste profile 338 may be updated based on behavioral data, such as purchase history, event-specific choices, or explicit feedback. The user interface 330 may enable a user to refine the taste profile 338.

The feedback 326 may include consumer feedback, provider feedback, and the like. The feedback 326 may include a request to regenerate the wine recommendation 334, explicit ratings (e.g., user scores for pairings) of the wine recommendation 334, and/or implicit ratings (e.g., time spent exploring certain wines). The feedback 326 may also include user ratings, purchase behaviors, and repeat interactions. The feedback 326 may include a user-rated accuracy of the wine recommendation 334 for the food description 324. The feedback 326 may include an option to customize and save the food description 324 and the wine recommendation 334.

The training data 328 may integrate data from various sources. The training data 328 may include a dataset of the food description 324, the feedback 326, the sensor data 336, the taste profile 338, the user-specific wine preference 342, the inventory levels 344, the contextual factors 346, and/or the flavor vectors 350. The training data 328 may combine sensory data (e.g., flavor chemistry analysis), user preferences, and crowdsourced reviews into a unified training set. The training data 328 may be a bias-minimized training dataset that may be diverse and unbiased. The training data 328 may ensure generalizability across regions, cuisines, and wine styles. The training data 328 may include cultural and regional pairing nuances. The training data 328 may minimize cultural and personal biases by using diverse training datasets, offering fair and inclusive recommendations. The training data 328 may also be an expert-augmented dataset. Detecting and eliminating biases in the training data 328 may ensure that the large language model 322 can generalize across diverse cuisines, wine varieties, and cultural contexts. The training data 328 may also integrate sommelier expertise, using structured interview data and expert scoring. The training data 328 may be a multi-source training dataset with integrated expert feedback and chemical profiling.

The flavor vectors 350 may include flavor profiles for wines and food. The flavor profiles may be based on flavor vectors and/or the feedback 326. In embodiments, the database 318 may include the flavor vectors 350 of wine and/or food. The flavor vectors 350 may be a chemical composition of the wine and food. The wine and food may be encoded into high-dimensional flavor vectors. Each dimension of the flavor vectors may correspond to a percentage inclusion of a chemical compound. The flavor vectors 350 may include sensory data and chemical composition of wines and foods. The flavor vectors 350 may provide scientific precision based on chemical analysis to ensure the wine recommendation 334 is accurate. The flavor vectors 350 may link wines and food dishes based on chemical compositions, flavor profiles, and sensory pairings. The link may indicate flavor compatibility. The flavor vectors 350 may be maintained as any suitable data type, such as, but not limited to, a structured dataset with chemical flavor compounds.

The flavor vectors 350 may be based on the sensor data 336, expert inputs, sensory analyses, crowd-sourced data, and the like. In embodiments, the flavor vectors 350 may be based on the feedback 326. For example, the flavor vectors 350 may be self-enriching by being built from the feedback 326 from sommeliers and consumers. The feedback 326 may provide subjective opinions when generating the wine recommendation 334. The flavor vectors 350 may be updated with refinements based on evolving trends and new data inputs.

The sensor devices 308 may be internet-of-things (IoT) devices, thermometers, pH sensors, chemical composition sensors, a flavor profile sensor, or the like. The sensor devices 308 may collect sensor data 336. The sensor devices 308 may collect the sensor data 336 in real-time or at an interval. The sensor data 336 may be data of wine and/or food. For example, the sensor data 336 may include, but is not limited to, temperature, pH level, chemical composition, a flavor profile (e.g., sweet, sour, salty, bitter, and umami), or the like. The sensor devices 308 may generate chemical profiles of food and/or wine to refine the flavor vectors 350.

The server 302 may perform multi-source data fusion. Performing multi-source data fusion may enable the server 302 to perform holistic decision-making. The server 302 may receive and/or fuse any of the various data for storage in the database 318 from one or more sources. The server 302 may include connections to the computing devices 306, the sensor devices 308, and/or the inventory-tracking system 310 via the network 304. The server 302 may receive the various data from the computing devices 306, the sensor devices 308, and/or the inventory-tracking system 310. The server 302 may integrate data from multiple sources, such as the computing devices 306, the sensor devices 308, and/or the inventory-tracking system 310, leading to training insights. The server 302 may integrate the data in real-time. For example, the server 302 may receive the sensor data 336 from the sensor devices 308. By way of another example, the server 302 may receive the taste profile 338 from the computing devices 306 and/or the inventory-tracking system 310. By way of another example, the server 302 may receive the food description 324, the feedback 326, the user-specific wine preference 342, and/or the contextual factors 346 from the computing devices 306. Thus, the server 302 may include real-time inputs from users. By way of another example, the server 302 may receive the inventory levels 344 from the inventory-tracking system 310. The data may be securely transmitted to the server 302 for processing and integration into the taste profile 338. The server 302 may combine user feedback, expert insights, contextual inputs, and chemical flavor data into a unified recommendation engine for robust pairing logic.

The computing devices 306 may include an application or web portal for accessing one or more features of the server 302, such as, but not limited to, accessing the large language model 322, viewing recommendations, and the like. The application may be a consumer-facing application, which may provide recommendations to a consumer. By way of another example, the application may be a provider-facing application, which may provide recommendations to waitstaff, a bartender, a sommelier, or the like.

The large language model 322 may also be referred to as a chatbot, an artificial-intelligence (AI)-powered chatbot, a conversational AI, a virtual assistant, or the like. The large language model 322 may be a neural network, such as, but not limited to, a transformer model (e.g., Generative Pre-Trained Transformer (GPT), Bidirectional Encoder Representations from Transformers (BERT)) or the like. The large language model 322 may be a context-aware conversational artificial intelligence. The large language model 322 may be a recommendation engine, which may generate a wine recommendation 334. The large language model 322 may provide a conversational interface for real-time food and wine pairing queries.

The server 302 may construct the prompt 332. The program instructions 320 may be executed by the processors 314 to construct the prompt 332. The prompt 332 may be a context-rich prompt. The prompt 332 may be a structured prompt for the large language model 322. The prompt 332 may be a structured-text input for the large language model 322. The prompt 332 may specify an engine of the large language model 322, tokens for the wine recommendation 334, a randomness (e.g., temperature) of the large language model 322, and the like.

The server 302 may construct the prompt 332 based on the food description 324, the feedback 326, the sensor data 336, the taste profile 338, the user-specific wine preference 342, the inventory levels 344, the contextual factors 346, and/or the flavor vectors 350. The prompt 332 may be a structured prompt combining user input with a predefined knowledge base. The prompt 332 may instruct the large language model 322 to generate the wine recommendation 334 based on the food description 324, the feedback 326, the sensor data 336, the taste profile 338, the user-specific wine preference 342, the inventory levels 344, the contextual factors 346, and/or the flavor vectors 350. For example, the prompt 332 may be of the form: “You are a world-class sommelier AI specializing in food and wine pairing. Consider the user's preferences and the dish description to recommend an ideal wine pairing.” The food description 324, the feedback 326, the sensor data 336, the taste profile 338, the user-specific wine preference 342, the inventory levels 344, the contextual factors 346, and/or the flavor vectors 350 may be included in (e.g., prepended to and/or appended to) the prompt 332.

The large language model 322 may be queried to generate a wine recommendation 334. The server 302 may query the large language model 322 using the prompt 332 to generate the wine recommendation 334. The large language model 322 may generate the wine recommendation 334 based on the prompt 332. The large language model 322 may process the prompt 332 using natural-language processing to generate the wine recommendation 334. The large language model 322 may return the wine recommendation 334 as an output from the prompt 332. The wine recommendation 334 may be an AI-generated response. The wine recommendation 334 may enhance a culinary experience by elevating a sensory harmony between food and wine.

The large language model 322 may generate the wine recommendation 334 based on the food description 324, the feedback 326, the sensor data 336, the taste profile 338, the user-specific wine preference 342, the inventory levels 344, the contextual factors 346, and/or the flavor vectors 350 in the prompt 332. The wine recommendation 334 may provide personalized recovery advice with contextual understanding based on the food description 324, the feedback 326, the sensor data 336, the taste profile 338, the user-specific wine preference 342, the inventory levels 344, the contextual factors 346, and/or the flavor vectors 350. The wine recommendation 334 may be adapted dynamically to real-time inputs or evolving circumstances. The wine recommendation 334 may be dynamically adapted to individual consumer needs based on the food description 324, the feedback 326, the sensor data 336, the taste profile 338, the user-specific wine preference 342, the inventory levels 344, the contextual factors 346, and/or the flavor vectors 350. The large language model 322 may adapt the wine recommendation 334 in real-time to user preferences, feedback, and contextual data, offering a customized recommendation.

The large language model 322 may include a processing pipeline with one or more layers. The processing pipeline may process inputs using machine learning models to generate the wine recommendation 334, which is tailored to the inputs. The large language model 322 may include one or more layers, such as, but not limited to, an input layer 352, an output layer 354, a flavor-composition layer 356, a profile-adaptation layer b, a contextual-adaptation layer 360, an inventory-adaptation layer 362, a feedback-adaptation layer 364, and the like. The layers may be neurons in a neural network of the large language model 322, where the neurons may perform computations on the prompt 332. The neurons of the input layer 352, the output layer 354, the flavor-composition layer 356, the profile-adaptation layer 358, the contextual-adaptation layer 360, the inventory-adaptation layer 362, and/or the feedback-adaptation layer 364 may be connected by weights and thresholds. The flavor-composition layer 356, the profile-adaptation layer 358, the contextual-adaptation layer 360, the inventory-adaptation layer 362, and/or the feedback-adaptation layer 364 may connect between the input layer 352 and the output layer 354. The specific architecture of the arrangement and number of neurons in the layers is not intended to be limiting, and is merely exemplary of the large language model 322.

The food description 324, the feedback 326, the prompt 332, the sensor data 336, the taste profile 338, the user-specific wine preference 342, the inventory levels 344, the contextual factors 346, and/or the flavor vectors 350, may be input to the input layer 352 of the large language model 322. The wine recommendation 334 may be output from the output layer 354 of the large language model 322.

The wine recommendation 334 may be paired with the food description 324 based on the flavor vectors 350. The large language model 322 may include the flavor-composition layer 356 for generating the wine recommendation 334 based on the food description 324 and the flavor vectors 350. The large language model 322 may use the food description 324 and the flavor vectors 350 when generating the wine recommendation 334. The large language model 322 may use the food description 324 and the flavor vectors 350 when generating the wine recommendation 334 to generate optimal pairings based on wine that has a complementary flavor with the food description 324, as indicated by the flavor vectors 350. The large language model 322 may match the flavor vectors 350 associated with the food description 324 with a wine that pairs well with the flavor vectors 350. The large language model 322 may encode the food description 324 into features using a chemical and sensory data model, and then find a wine associated with the features in the flavor vectors 350. The large language model 322 may generate the wine recommendation 334 based on features extracted from the food description 324 and the flavor vectors 350. The large language model 322 may execute a feature extraction algorithm to extract the feature vectors from the food description 324. The feature vectors extracted from the food description 324 may be cross-linked with feature vectors associated with a wine, for selection as the wine recommendation 334. The large language model 322 may use the flavor vectors 350 to enhance pairing precision when generating the wine recommendation 334. The flavor vectors 350 may enable precise pairing through scientific analysis of chemical and sensory properties. The flavor vectors 350 may enable the large language model 322 to perform data-driven wine and food pairing. The inclusion of the flavor vectors 350 may add an objective dimension to the pairing process, beyond human heuristics. The flavor vectors 350 may enable generating the wine recommendation 334 with validations from flavor principles, enhancing the credibility of the wine recommendation 334. For example, the flavor-composition layer 356 may ensure scientifically accurate pairings by analyzing chemical and sensory data for foods and wines.

The large language model 322 may personalize the wine recommendation 334 based on the taste profile 338. The large language model 322 may include the profile-adaptation layer 358 for adapting the wine recommendation 334 based on the taste profile 338. For example, the large language model 322 may personalize the wine recommendation 334 based on individual user preferences, taste history, the user-specific wine preference 342, and/or the feedback 326. The taste profile 338 may be used to refine the wine recommendation 334. The wine recommendation 334 generated by the large language model 322 may be highly tailored and/or personalized by generating the wine recommendation 334 based on the taste profile 338. The large language model 322 may use collaborative-based filtering and/or content-based filtering when generating the wine recommendation 334. In embodiments, the large language model 322 may use collaborative-based filtering when generating the wine recommendation 334. The large language model 322 may include a clustering algorithm that may group together similar ones of the taste profile 338. The clustering algorithm may analyze the taste profile 338 and historical data for refined pairing suggestions. The large language model 322 may then generate the wine recommendation 334 based on the feedback 326 from the taste profile 338 that are like the flavor profile of the user. In embodiments, the large language model 322 may use content-based filtering when generating the wine recommendation 334. The large language model 322 may use the feedback 326 from the user in the taste profile 338 to refine the wine recommendation 334. For example, the feedback 326 may refine the understanding of the user’s taste over time (e.g., preferred sweetness, tannin levels, or acidity in wines).

The large language model 322 may refine the wine recommendation 334 based on the contextual factors 346. The large language model 322 may include the contextual-adaptation layer 360 for adapting the wine recommendation 334 based on the contextual factors 346. The contextual-adaptation layer 360 may adapt the wine recommendation 334 based on seasonality (e.g., lighter wines for summer dishes, heavier reds for winter meals), environmental data (e.g., time of day, event type, season), event-specific factors, cultural factors, and the like within the contextual factors 346. The large language model 322 may dynamically adjust the importance of the contextual factors 346 when generating the wine recommendation 334, ensuring practical and relevant recommendations. The wine recommendation 334 may ensure culturally and contextually appropriate pairings for diverse users and settings. The use of the contextual factors 346 in generating the wine recommendation 334 may bridge cultural and culinary diversity and may provide culturally sensitive recommendations, ensuring alignment with regional and traditional pairing practices. The large language model 322 may be an event-specific algorithm that may dynamically adjust the wine recommendation 334 to meet unique events (e.g., weddings, casual dinners). The large language model 322 may perform environmental adjustments, such that the wine recommendation 334 is adjusted based on external variables such as ambient temperature, humidity, and time of day. The large language model 322 may perform event-based pairing, such that the wine recommendation 334 is adjusted based on specific event types, dietary requirements, and regional culinary practices. The large language model 322 may provide event-specific pairing to tailor the wine recommendation 334 for events like weddings, corporate gatherings, and themed dinners. The large language model 322 may accommodate dietary requirements, diverse dietary restrictions, and/or cultural preferences.

The large language model 322 may refine the wine recommendation 334 based on the inventory levels 344. The large language model 322 may include the inventory-adaptation layer 362 for adapting the wine recommendation 334 based on the inventory levels 344. The wine recommendation 334 may be adjusted based on the inventory levels 344 to ensure that the wine recommendation 334 is in-stock and actionable for purchase. The server 302 may synchronize with the inventory-tracking system 310 to ensure the inventory levels 344 are maintained in real-time. For example, the server 302 may be integrated with the inventory-tracking system 310 via application programming interfaces, or the like, to check the available stock. The large language model 322 may compare the wine recommendation 334 with the inventory levels 344 in real-time, and adjust the wine recommendation 334 to include wines that are currently available in the inventory levels 344. Where the wine in the wine recommendation 334 is unavailable, the large language model 322 may replace the wine with a similar wine that is available in the inventory levels 344. The large language model 322 may or may not change the wine in the wine recommendation 334 if the wine is available in the inventory levels 344. The large language model 322 may prioritize the pairings based on the inventory levels 344, ensuring practical suggestions.

The large language model 322 may refine the wine recommendation 334 based on the feedback 326. The large language model 322 may include the feedback-adaptation layer 364 for adapting the wine recommendation 334 based on the feedback 326. The feedback 326 may be real-time feedback for adapting the wine recommendation 334. For example, the feedback 326 may be post-interaction feedback that may be generated by the computing devices 306 after the large language model 322 generates the wine recommendation 334 and the computing devices 306 display the wine recommendation 334. The large language model 322 may receive the feedback 326 and adapt the wine recommendation 334. The large language model 322 may use the feedback 326 in a loop to enhance the accuracy and personalization of the wine recommendation 334 in real-time. For example, the large language model 322 may provide instantaneous adjustment of the wine recommendation 334 based on the feedback 326, such as adding or removing ingredients or the like.

An example of generating the wine recommendation 334 is now provided. The food description 324 may be of the form: "Grilled salmon with honey-mustard glaze, roasted asparagus, lemon butter sauce." The taste profile 338 may be of the form: Preferred Wines: ["Dry Red", "Light White"]. Avoid: ["Sweet Wines", "Sparkling Wines"]. The contextual factors 346 may be of the form: "Romantic dinner at home". Based on these inputs, the large language model 322 may generate the wine recommendation 334 of the form: "For this dish, a lightly oaked Chardonnay would pair beautifully, complementing the lemon butter sauce and the honey-mustard glaze with its subtle creaminess and citrus notes. If you prefer a red wine, a light Pinot Noir with its soft tannins and berry undertones would enhance the salmon without overpowering it."

The computing devices 306 may receive the wine recommendation 334 from the server 302 and display the wine recommendation 334. The user interface 330 may display the wine recommendation 334. The wine recommendation 334 may be displayed by the user interface 330 through an application, portals, integrated systems, or the like. The wine recommendation 334 may be displayed to the user, such as the consumer and/or the providers. The display may be optimized for the computing devices 306 (e.g., mobile app, kiosk, or the like). The user interface 330 may display the wine recommendation 334 via any suitable technique, such as, but not limited to, a text display, a visual flavor mapping, augmented reality/virtual reality (AR/VR) displays, or the like. The visual flavor mapping may include pairing heatmaps, dynamic flavor wheels, or the like. The visual flavor mapping may enhance user understanding and interaction. The augmented reality/virtual reality displays may provide an immersive and interactive pairing experience. The user interface 330 may include interactive features that may enhance user engagement and understanding of the wine recommendation 334.

The server 302 may be configured to train the large language model 322. The server 302 may train the large language model 322 by dynamic dataset updates, self-enriching models, long-term learning and improvement, reinforcement learning, a hybrid human-AI review cycle, or the like. The large language model 322 may be a self-enriching AI model that may improve over time by learning. The wine recommendation 334 may be validated to retrain and refine the large language model 322, improving long-term reliability and precision. The server 302 may continuously train the large language model 322 to improve the generation of the wine recommendation 334 over time. The large language model 322 may stay relevant and responsive to evolving trends and preferences by being retrained. The training may ensure the large language model 322 remains both dynamic and deeply aligned with the complexities of food and wine pairing.

The server 302 may train the weights and/or thresholds of the input layer 352, the output layer 354, the flavor-composition layer 356, the profile-adaptation layer 358, the contextual-adaptation layer 360, the inventory-adaptation layer 362, and/or the feedback-adaptation layer 364. The large language model 322 may be trained to weigh the food description 324, the feedback 326, the prompt 332, the sensor data 336, the taste profile 338, the user-specific wine preference 342, the inventory levels 344, the contextual factors 346, and/or the flavor vectors 350 when generating the wine recommendation 334. The server 302 may train the large language model 322 using the food description 324, the feedback 326, the prompt 332, the sensor data 336, the taste profile 338, the user-specific wine preference 342, the inventory levels 344, the contextual factors 346, and/or the flavor vectors 350. The server 302 may train the large language model 322 using the training data 328. The large language model 322 may be trained on the taste profile 338 to improve the generation of the wine recommendation 334 after training. The large language model 322 may be trained with the feedback 326. The user reinforcement may be used by the large language model 322 to evaluate the success of the wine recommendation 334 based on the feedback 326. The large language model 322 may use the feedback 326 to provide contextual adjustments when updating the wine recommendation 334. The feedback 326 may be processed in real-time to fine-tune the generation of the wine recommendation 334 for greater accuracy. The large language model 322 may be trained based on user ratings for the pairing in the feedback 326, refining future recommendations for similar dishes or occasions. The large language model 322 may learn to identify complementary or contrasting flavor pairings using the flavor vectors 350 and the feedback 326. The large language model 322 may create context-appropriate pairings that suit diverse preferences and dietary requirements. The large language model 322 may offer regionally appropriate recommendations.

The server 302 may train the large language model 322 using supervised learning and/or unsupervised clustering. Supervised learning may include labeled preferences. Unsupervised clustering may identify hidden patterns in the taste profile 338. The server 302 may also train the large language model 322 using reinforcement learning. For instance, the large language model 322 may be trained using reinforcement learning. Successful interactions may be rewarded using reinforcement learning in the large language model 322 to reinforce beneficial behaviors and minimize negative behaviors. The reinforcement learning may reward the large language model 322 when the wine recommendation 334 is successful, guiding subsequent retraining cycles. The server 302 may also perform a hybrid human-AI review cycle where human experts validate the wine recommendation 334 generated by the server 302. Experts or sommeliers may validate the wine recommendation 334 via the feedback 326, which may be weighted more heavily in retraining cycles. The large language model 322 may be retrained periodically using reinforcement learning to align with evolving user preferences and inventory changes. The feedback 326 may be analyzed using reinforcement learning techniques to improve the accuracy and relevance of the large language model 322. The feedback 326 may provide a mechanism by which user feedback may be used to directly retrain or fine-tune the large language model 322 using reinforcement learning. The reinforcement learning may refine the ability of the large language model 322 to weigh the food description 324, the feedback 326, the prompt 332, the sensor data 336, the taste profile 338, the user-specific wine preference 342, the inventory levels 344, the contextual factors 346, and/or the flavor vectors 350 for more relevant pairings.

The large language model 322 may improve accessibility of the wine recommendation 334. The system 300 may be scalable. The system 300 may be scalable, democratizing access to expert-level pairings for diverse users. The system 300 may provide expert insights that are typically inaccessible to the average consumer. The system 300 may democratize expert knowledge by offering expert-level pairing guidance to non-experts, making accessible the wine recommendation 334. The system 300 may make expert-level wine and food pairing accessible to non-experts at an affordable price, democratizing a traditionally high-end service. The large language model 322 generating the wine recommendation 334 may reduce the need for costly sommelier services, making professional-grade recommendations affordable and scalable.

The system 300 may be used for various applications. The system 300 may accommodate both consumer-level simplicity (mobile apps, chatbots) and professional-grade features (restaurant dashboards, wine profiling sensors), ensuring versatility and scalability across various use cases. The system 300 may help consumers make informed pairing choices for personal dining, parties, or special occasions. The system 300 may support users such as individual consumers and large-scale applications (e.g., restaurants, caterers, wine retailers, large-scale events). The system 300 may enable scalable pairing recommendations for events, restaurants, and retail applications without the need for a human sommelier. The system 300 may provide dynamic, real-time suggestions when shopping for wine or planning meals. The system 300 may integrate with digital menus to recommend pairings for menu items. The system 300 may design menus and wine lists that align with customer preferences. The system 300 may integrate with catering tools to ensure pairing consistency for large events. The system 300 may integrate with wine retailing systems to recommend wines to customers based on their purchase history and planned meals. The system 300 may generate the wine recommendation 334 in real time for high-demand environments. The system 300 may be capable of managing high demand and offering consistent recommendations across diverse audiences. The system 300 may support a wide range of cuisines, wine styles, and cultural traditions, making it suitable for a global audience.

The system 300 may also provide educational content. The system 300 may double as an educational resource for wine enthusiasts, teaching users about pairing principles and flavor profiles. The system 300 may integrate educational tools that teach users about pairing principles, flavor profiles, and wine characteristics. The system 300 may include gamified features to engage users in learning about pairings while refining their preferences. The system 300 may double as a learning tool for users to understand wine characteristics and pairing principles, enriching their culinary knowledge.

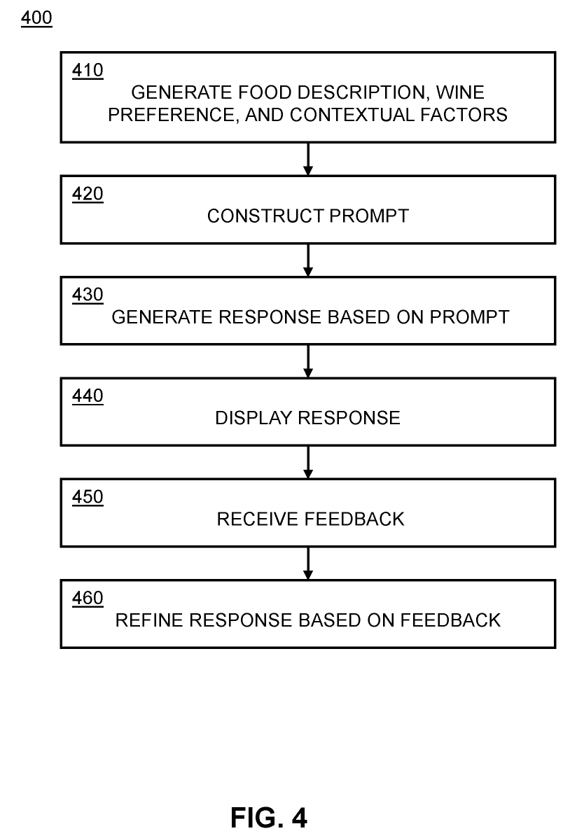

FIG. 4 depicts a flow diagram of a method 400, in accordance with one or more embodiments of the present disclosure. The method 400 may be a multi-layered constraint tuning (MLCT) method. The method 400 may ensure personalization, context-awareness, and adaptability for superior food and wine pairing recommendations. The method 400 may personalize the wine recommendation 334 and deliver the wine recommendation 334, which is uniquely tailored to individual preferences and contexts. The method 400 may be adapted for dynamic food and wine pairing to ensure personalized, context-aware, and precise recommendations. The method 400 may involve tuning across multiple layers, each addressing a key aspect of the pairing process. The method 400 may be implemented by the program instructions 320 executable by the processors 314. The embodiments and enabling technologies described previously herein in the context of the system 300 should be interpreted to extend to method 400. It is further noted, however, that the method is not limited to the architecture of the system 300.

In a step 410, the user interface 330 may generate the food description 324, the user-specific wine preference 342, and/or the contextual factors 346. For example, the user may input the food description 324, the user-specific wine preference 342, and/or the contextual factors 346 into the user interface 330.

In a step 420, the program instructions 320 may construct the prompt 332. The program instructions 320 may construct the prompt based on the food description 324, the feedback 326, the sensor data 336, the taste profile 338, the user-specific wine preference 342, the inventory levels 344, the contextual factors 346, and/or the flavor vectors 350.

In a step 430, the large language model 322 may generate the wine recommendation 334 based on the prompt 332. The wine recommendation 334 may be personalized based on the food description 324, the feedback 326, the sensor data 336, the taste profile 338, the user-specific wine preference 342, the inventory levels 344, the contextual factors 346, and/or the flavor vectors 350 included in the prompt 332.

In a step 440, the user interface 330 may display the wine recommendation 334.

In a step 450, the user interface 330 may receive the feedback 326. For example, the user may input the feedback 326 into the user interface 330.

In a step 460, the large language model 322 may refine the wine recommendation 334 based on the feedback 326. The feedback 326 may be used to refine the wine recommendation 334. The feedback 326 may guide an immediate update of the wine recommendation 334.

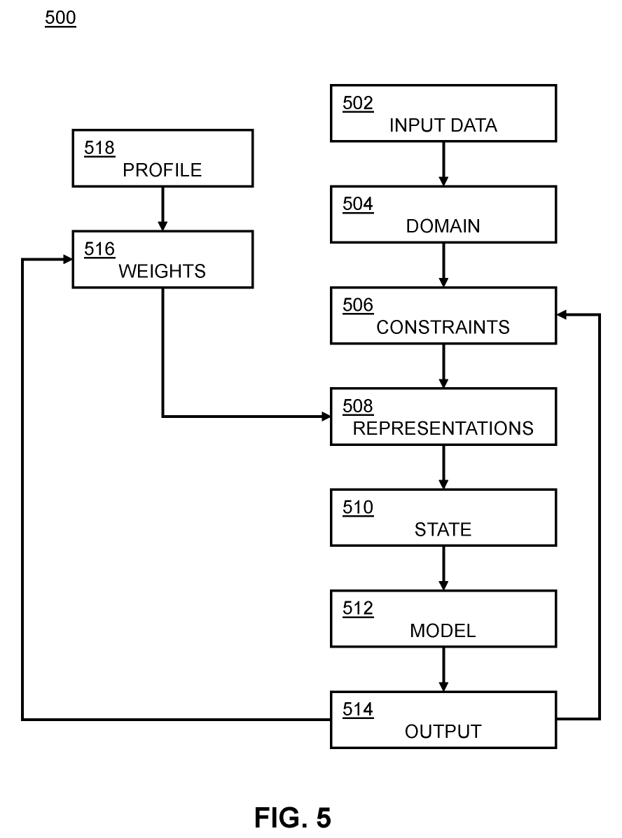

FIG. 5 illustrates a flow diagram of a MLCT architecture 500, in accordance with one or more embodiments of the present disclosure. The MLCT architecture 500 may be implemented by the program instructions 320 executable by the processors 114 and/or the processors 314. The embodiments and enabling technologies described previously herein in the context of the system 100 and/or the system 300 should be interpreted to extend to the MLCT architecture 500. It is further noted, however, that the MLCT architecture 500 is not limited to the architecture of the system 100 and/or the system 300. The MLCT architecture 500 provides a framework for transforming input data into the structured constraint representations 508 and constructing the constrained inference execution state 510 prior to execution of the probabilistic model 512. The MLCT architecture 500 is a structured, multi-stage inference control architecture.

The MLCT architecture 500 may receive the input data 502. The input data 502 may include any suitable data input to the MLCT architecture 500, such as, but not limited to, user input data, sensor data, profile data, contextual factors, and the like. The input data 502 may also be specific to the domain 504 of the MLCT architecture 500. For example, the input data 502 may include patient profiles, taste profiles, or the like. The input data 502 may include sensitive information, such as personally identifiable information (PII).

The MLCT architecture 500 may classify the domain 504 of the input data 502. The domain 504 may be an environment in which the MLCT architecture 500 may be applied. The domain 504 of the MLCT architecture 500 may be applied across multiple environments. For example, the domain 504 may include, but is not limited to, healthcare systems, recommendation systems (e.g., food and drink recommendation systems), financial systems, regulated systems, enterprise artificial intelligence platforms, and various other implementations of the probabilistic model 512. While specific embodiments are described herein with respect to healthcare systems and food and wine recommendation systems, this is not intended to be limiting. The MLCT architecture 500 may classify the domain 504 using any suitable process. For example, the MLCT architecture 500 may classify the domain 504 associated with the input data 502 using semantic analysis, or the like. Although the MLCT architecture 500 is described as classifying the domain 504, this is not intended as a limitation of the present disclosure. It is further contemplated that the input data 502 may include a selection of the domain 504.

The MLCT architecture 500 may identify the constraints 506. For example, the MLCT architecture 500 may identify the constraints 506 associated with the domain 504. The constraints 506 may be rules associated with the domain 504. The constraints 506 may be determined a priori and may be associated with the domain 504 in a lookup table, or the like.

The MLCT architecture 500 may generate the structured constraint representations 508 from the input data 502 and the constraints 506. The structured constraint representations 508 encode the input data 502 and the constraints 506 of the domain 504 into a structured form. The structured form may include, but is not limited to, tokens or the like. The structured constraint representations 508 may include a vector-based representation, a rule-based representation, a hybrid representation, or the like. The hybrid representation may be a hybrid of a vector representation and a rule-based representation.

The MLCT architecture 500 may transform the input data 502 into the structured constraint representations 508. The transformation of the input data 502 into the structured constraint representations 508 provides abstraction of the input data 502 into the structured constraint representations 508. The transformation includes abstraction of the input data 502 into the structured constraint representations 508 to minimize propagation of non-essential information. In embodiments, the input data 502 is transformed to the structured constraint representations using one or more constraint transformation layers. For example, the MLCT architecture 500 may transform the input data 502 to the structured constraint representations 508 using a multi-layer constraint transformation. For instance, the MLCT architecture 500 may transform the input data 502 to the structured constraint representations 508 by removing non-essential information in the input data 502, masking or omitting identifying attributes (e.g., personally identifiable information), reducing the input data 502 to attributes that are relevant to the constraints 506, abstracting into the structured constraint representations 508, or the like.

The MLCT architecture 500 may transform the constraints 506 to the structured constraint representations 508. The structured constraint representations 508 may be features of the constraints 506. The structured constraint representations 508 are relevant to the constraints 506. The MLCT architecture 500 extracts the structured constraint representations 508 of the constraints 506. The transformation of the constraints 506 to the structured constraint representations 508 may be deterministic. For example, the transformation may be deterministic using one or more deterministic models or rules-based systems. The structured constraint representations 508 are generated independently of external document injection. The structured constraint representations 508 may be generated using one or more constraint transformation layers. The constraint transformation layers identify domain-specific constraints, remove or mask non-essential or sensitive attributes, and generate structured constraint representations.

The MLCT architecture 500 may weight and adapt the structured constraint representations 508 based on contextual and profile-specific factors. The MLCT architecture 500 may apply the contextual weights 516 to the constraints 506 in the structured constraint representations 508. The contextual weights 516 may assign relative importance to the constraints 506. The contextual weights 516 may weigh the constraints 506 based on one or more factors, such as, but not limited to, contextual factors, user-specific attributes, system-level policies, and the like. The MLCT architecture 500 may adapt the contextual weights 516 based on the profile 518 prior to applying the contextual weights 516 to the constraints 506. The adaptation of the contextual weights 516 applies modifiers that influence prioritization of the constraints 506. The modifiers may include any suitable modifiers. For example, the profile 518 may apply user-level modifiers and/or system-level modifiers to the contextual weights 516. The user-level modifiers may include modifiers associated with the user inputting the input data 502. The system-level modifiers may include modifiers associated with the MLCT architecture 500 across all users.

The MLCT architecture 500 may construct the constrained inference execution state 510. The constrained inference execution state 510 may be a structured constraint-driven execution state. The MLCT architecture 500 may construct the constrained inference execution state 510 using the structured constraint representations 508 (e.g., after applying the contextual weights 516). In embodiments, the constrained inference execution state 510 excludes the input data 502 and includes the structured constraint representations 508. The transformation of the input data 502 to the structured constraint representations 508 may modify the constrained inference execution state 510. The MLCT architecture 500 may construct the constrained inference execution state 510 using the structured constraint representations 508 in response to applying the contextual weights 516 to the constraints 506 in the structured constraint representations 508. Transforming the input data 502 to the structured constraint representations 508 limits propagation of sensitive information within the constrained inference execution state 510. The structured constraint representations 508 modify the constrained inference execution state 510 of the probabilistic model 512. The MLCT architecture 500 modifies the constrained inference execution state 510 of inference through the structured constraint representations 508.

The MLCT architecture 500 may be applied to the probabilistic model 512. The probabilistic model 512 may include any suitable model, such as, but not limited to, the large language model 122, the large language model 322, or the like.

In certain embodiments, prompt construction for the probabilistic model 512 may be replaced, supplemented, and/or constrained by the construction of the constrained inference execution state 510 using the MLCT architecture 500. The MLCT architecture 500 may operate as a control layer governing inference execution of the probabilistic model 512. The probabilistic model 512 executes using the constrained inference execution state 510 to generate the output 514. The constrained inference execution state 510 defines parameters governing the behavior of the probabilistic model 512. For example, the constrained inference execution state 510 defines parameters governing behavior of the probabilistic model 512 during inference. The probabilistic model 512 may generate the output 514 that is constrained by the structured constraint representations 508. The constrained inference execution state 510 enables the probabilistic model 512 to generate the output 514 that is contextually relevant, personalized, and consistent with the constraints 506 of the domain 504.

The constrained inference execution state 510 minimizes reliance on the inclusion of the input data 502. Transforming the input data 502 reduces exposure of sensitive information to the probabilistic model 512 during inference. The MLCT architecture 500 does not rely on direct injection of the input data 502 into the inputs of the probabilistic model 512, external document retrieval, or the like. Instead, the input data 502 is transformed into the structured constraint representations 508 prior to inference execution. The MLCT architecture 500 provides a security-enhancing inference control mechanism by limiting exposure of the input data 502 to the probabilistic model 512. The structured constraint representations 508 reduce exposure of the input data 502, limit propagation of sensitive information, and enable controlled construction of the constrained inference execution state 510. The transformation of the input data 502 into the structured constraint representations 508 and construction of the constrained inference execution state 510 reduce inclusion of the input data 502 in the input of the probabilistic model 512 and limit exposure of sensitive information during inference, thereby improving security, privacy, and execution control of the probabilistic model 512. The transformation of the input data 502 into the structured constraint representations 508 enables reduction or elimination of the inclusion of the input data 502 in inputs of the probabilistic model 512, removal or masking of sensitive attributes prior to inference, and prevention of unnecessary propagation of identifying or confidential information. Not containing the input data 502 in the constrained inference execution state 510 results in a reduced attack surface during inference, improved data privacy and confidentiality, and controlled exposure of information to the probabilistic model 512. Security properties emerge from transforming the input data 502 to the structured constraint representations 508, rather than from post-processing or filtering mechanisms. The multi-layer constraint tuning process reduces an inference attack surface by limiting accessibility of the input data 502 during execution of the probabilistic model 512.

The MLCT architecture 500 may validate the output 514. For example, the MLCT architecture 500 validates the output 514 for adherence to the constraints 506. The validation of the output 514 may influence subsequent generation of the constraints 506. The MLCT architecture 500 may provide several benefits, such as improving consistency and validity of the output 514, enforcing constraint-consistent inference behavior, producing domain-consistent outputs, and the like.

The MLCT architecture 500 may operate as a closed-loop inference control system. The output 514 may be fed back into the MLCT architecture 500 for iterative refinement. The MLCT architecture 500 may use the output 514 in a feedback loop. For example, the MLCT architecture 500 may adjust the constraints 506, the contextual weights 516, or the like based on the output 514 in a feedback loop. The feedback mechanisms may include adjusting the contextual weights 516 of the constraints 506 and modifying future generation of the constraints 506. The arrows from the output 514 may indicate the feedback loop.

The MLCT architecture 500 may improve computational efficiency of the probabilistic model 512 by limiting the size of the input to the probabilistic model 512. For example, the size of the constrained inference execution state 510 may be abstracted and reduced from the input data 502. The MLCT architecture 500 improves computational efficiency by limiting processed input data and enforcing structured constraint-based inference.

The MLCT architecture 500 may or may not modify the weights of the probabilistic model 512. In embodiments, the MLCT architecture 500 controls inference execution without modifying the weights of the probabilistic model 512. For example, the constrained inference execution state 510 enforces the constraints 506 on the execution of the probabilistic model 512, without modifying the underlying weights of the probabilistic model 512. For instance, the constrained inference execution state 510 enforces the constraints 506 prior to inference execution while controlling behavior of the probabilistic model 512.

In embodiments, the probabilistic model 512 does not receive the input data 502. In embodiments, the MLCT architecture 500 transforms the input data 502 prior to inference execution of the probabilistic model 512. The MLCT architecture 500 transforms the input data 502 into the structured constraint representations 508 and subsequently the constrained inference execution state 510 prior to inference execution of the probabilistic model 512.

The MLCT architecture 500 may be executed iteratively, conditionally, in parallel, or the like. For example, one or more of the transformation, constraint generation, or execution-state construction steps are performed fully sequentially, partially applied, iteratively, conditionally, in parallel, or the like. For instance, the MLCT architecture 500 may include constraint transformation layers. The constraint transformation layers may be applied sequentially, independently, in parallel, iteratively, or the like. One or more of the layers may be applied independently or in combination, and the system need not implement all layers simultaneously.

In embodiments, the MLCT architecture 500 is implemented across a distributed computing environment. The MLCT architecture 500 may be implemented across distributed computing environments, such as, but not limited to, cloud-based systems, application programming interfaces (APIs), microservices, and the like. For example, the layers tuning the constraints 506 may be implemented as microservices.

In embodiments, the MLCT architecture 500 is an artificial intelligence system for pre- and post-operative care implemented using the MLCT architecture 500. The input data 502 may include the query 124, the sensor data 136 (e.g., physiological sensor data), the patient profile 138, the medical history, the discharge instructions 143, and the like. The patient profiles, sensor data, taste profile, contextual factors, and recommendation logic, are processed through the constraint transformation layers to generate the structured constraint representations 508 and construct the constrained inference execution state 510. The output 514 may include the response 134, the recovery plan 145, symptom assessments, clinical guidance, and the like.

In embodiments, the MLCT architecture 500 is an artificial intelligence system for dynamic food and wine pairing implemented using the MLCT architecture 500. The input data 502 may include the food description 324, the taste profile 338, the user-specific wine preference 342, the inventory levels 344, the contextual factors 346, the flavor vectors 350, and the like. The structured constraint representations 508 may reflect flavor compatibility, contextual conditions, and user-specific preferences. The output 514 may include the wine recommendation 334 for the food description 324.

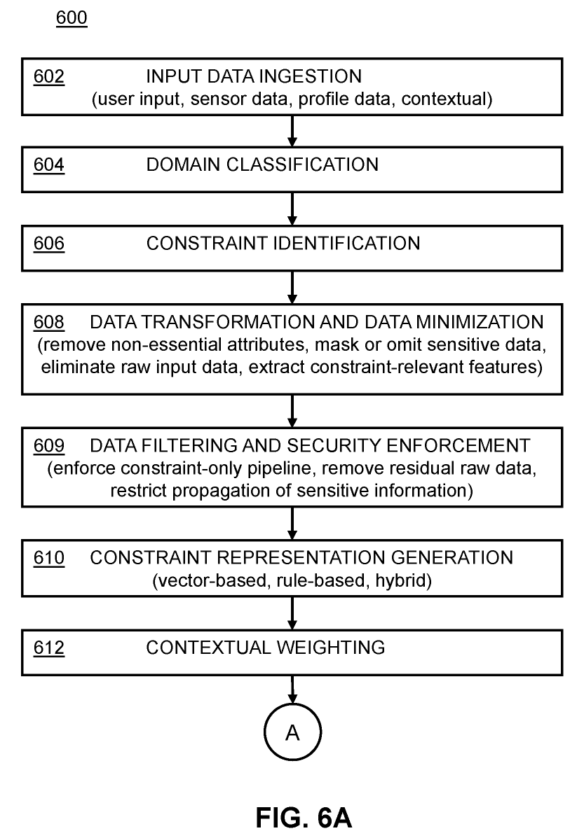

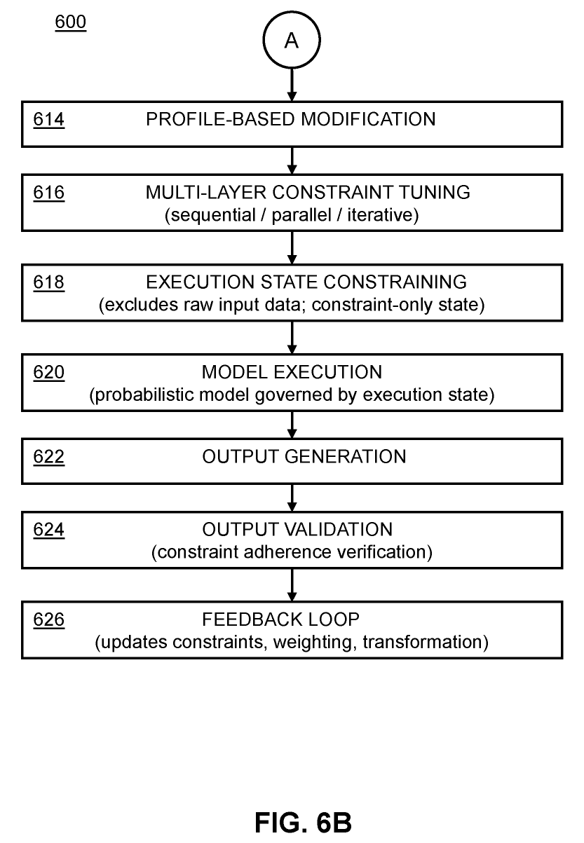

FIG. 6A-6B illustrate a detailed process flow of the MLCT architecture 600, in accordance with one or more embodiments of the present disclosure. The embodiments and enabling technologies described previously herein in the context of the MLCT architecture 500 should be interpreted to extend to the MLCT architecture 600. For example, the MLCT architecture 600 may be an expanded process flow of the MLCT architecture 500. The flow of the MLCT architecture 600 may include the input data ingestion 602, the domain classification 604, the constraint identification 606, the data transformation and data minimization 608, the data filtering and security enforcement 609, the constraint representation generation 610, the contextual weighting 612, the profile-based modification 614, the multi-layer constraint tuning 616, the execution state constraining 618, the model execution 620, the output generation 622, the output validation 624, and the feedback loop 626.

The MLCT architecture 600 may include the input data ingestion 602 of the input data 502. The input data ingestion 602 may include receiving the input data 502. The input data 502 may include user input, sensor data, profile data, contextual data, and the like. The input data ingestion 602 may receive the input data 502 from any of the various sources described herein.

The MLCT architecture 600 may include the domain classification 604. The domain classification 604 may classify the domain 504 of the input data 502. The domain classification 604 may classify the domain 504 of the input data 502 using any suitable technique, such as, but not limited to, by semantic analysis, by the input data 502 including a selection of the domain 504, or the like.

The MLCT architecture 600 may include the constraint identification 606. The constraint identification 606 may identify the constraints 506. For example, the constraint identification 606 may identify the constraints 506 of the input data 502 and/or the domain 504.

The MLCT architecture 600 may include the data transformation and data minimization 608. The data transformation and data minimization 608 may transform and/or minimize the input data 502. For example, the data transformation and data minimization 608 may remove non-essential attributes, mask or omit sensitive data, eliminate raw input data, and/or extract constraint-relevant features of the input data 502. The data transformation and data minimization 608 may be a pre-inference transformation boundary, a raw input, a system-level control plane, an architectural rule, or the like. The data transformation and data minimization 608 may occur before the inference execution.

The MLCT architecture 600 may include the data filtering and security enforcement 609. The data filtering and security enforcement 609 may enforce a constraint-only pipeline, remove residual raw data, and/or restrict propagation of sensitive information. For example, the data filtering and security enforcement 609 ensures constraint-only data propagation. The data filtering and security enforcement 609 may filter the input data 502 using one or more filters. The data filtering and security enforcement 609 may enforce one or more security rules for the input data 502. For example, the security enforcement may include constraint-only data propagation. The data filtering and security enforcement 609 may be a structural control layer of the MLCT architecture 600. The data filtering and security enforcement 609 may be a stage in the MLCT architecture 600 that ensures that transformed constraint-relevant data is propagated through the MLCT architecture 600. The data transformation and data minimization 608 and/or the data filtering and security enforcement 609 may remove, mask, and/or eliminate raw data.

The MLCT architecture 600 may include the constraint representation generation 610. The constraint representation generation 610 may generate the structured constraint representations 508. The constraint representation generation 610 may be vector-based, rule-based, and/or a hybrid thereof. The constraint representation generation 610 may be a processing step, a data operation, or the like. The constraint representation generation 610 may structure the input data 502 into the structured constraint representations 508 based on the constraints 506.

The MLCT architecture 600 may include the contextual weighting 612. The contextual weighting 612 may weight the constraints 506 and/or the structured constraint representations 508 using the contextual weights 516. For example, the contextual weighting 612 may weight the constraints 506 and/or the structured constraint representations 508 based on contextual factors, user-specific attributes, system-level policies, or the like.

The MLCT architecture 600 may include the profile-based modification 614. The profile-based modification 614 may modify the structured constraint representations 508. The profile-based modification 614 may apply modifiers to the structured constraint representations 508 that influence constraint prioritization.

The MLCT architecture 600 may include the multi-layer constraint tuning 616. The multi-layer constraint tuning 616 may be sequential, parallel, iterative, or the like. The multi-layer constraint tuning 616 may include tuning one or more layers of the structured constraint representations 508. The multi-layer constraint tuning 616 may tune the layers of the structured constraint representations 508 using the contextual weighting 612, the profile-based modification 614, and/or a structured assembly of the structured constraint representations 508.

The MLCT architecture 600 may include the execution state constraining 618. The execution state constraining 618 may constrain the constrained inference execution state 510 based on the structured constraint representations 508. The constrained inference execution state 510 may exclude the raw input data of the input data 502. The constrained inference execution state 510 may be a constraint-only state. The constrained inference execution state 510 may include the structured constraint representations 508. For example, the constrained inference execution state 510 may be a constraint-only execution.

The MLCT architecture 600 may include the model execution 620. The model execution 620 may execute the probabilistic model 512 using the constrained inference execution state 510. The probabilistic model 512 is governed by the constrained inference execution state 510. In certain embodiments, prompt construction for the probabilistic model 512 may be replaced, supplemented, and/or constrained by the construction of the constrained inference execution state 510 using the MLCT architecture 600. The input data 502 is transformed into the structured constraint representations 508, and no unprocessed input data is allowed to pass into the model execution 620.

The MLCT architecture 600 may include the output generation 622. The output generation 622 may generate the output 514. The model execution 620 executes the probabilistic model 512 using the constrained inference execution state 510, producing the output generation 622, which generates the output 514.

The MLCT architecture 600 may include the output validation 624. The output validation 624 may perform constraint adherence verification. The output validation 624 validates the output 514 against the constraints 506. For example, the output validation 624 may validate the output 514 for adherence with the constraints 506.

The MLCT architecture 600 may include the feedback loop 626. The feedback loop 626 may provide feedback to one or more steps of the MLCT architecture 600. The feedback loop 626 may be used to iteratively update one or more steps of the MLCT architecture 600. For example, the feedback loop 626 may provide feedback to input data ingestion 602, the domain classification 604, the constraint identification 606, the data transformation and data minimization 608, the data filtering and security enforcement 609, the constraint representation generation 610, the contextual weighting 612, the profile-based modification 614, the multi-layer constraint tuning 616, the execution state constraining 618, the model execution 620, the output generation 622, the output validation 624, or the like. For instance, the feedback loop 626 may provide feedback to the data filtering and security enforcement 609 and/or the constraint representation generation 610, although this is not intended to be limiting. The feedback loop 626 may update the constraints 506, the contextual weights 516, the transformation of the input data 502, the structured constraint representations 508, the constrained inference execution state 510, or the like. The feedback loop 626 may provide iterative refinement to any of the various components. The feedback loop 626 may be at the end of the MLCT architecture 600. The feedback loop 626 may loop for any number of iterations to retrain the MLCT architecture 600.

Referring generally again to the figures, one skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken as limiting.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

All of the methods described herein may include storing results of one or more steps of the method embodiments in memory. The results may include any of the results described herein and may be stored in any manner known in the art. The memory may include any memory described herein or any other suitable storage medium known in the art. After the results have been stored, the results can be accessed in the memory and used by any of the method or system embodiments described herein, formatted for display to a user, used by another software module, method, or system, and the like. Furthermore, the results may be stored “permanently,” “semi-permanently,” “temporarily,” or for some period. For example, the memory may be random access memory (RAM), and the results may not necessarily persist indefinitely in the memory.

It is noted herein that the one or more components of the system may be communicatively coupled to the various other components of the system in any manner known in the art. For example, the one or more processors may be communicatively coupled to each other and other components via a wireline connection or a wireless connection.

The herein described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively "associated" such that the desired functionality is achieved. Hence, any two components herein combined to achieve a particular functionality can be seen as "associated with" each other such that the desired functionality is achieved, irrespective of architectures or intermediate components. Likewise, any two components so associated can also be viewed as being "connected," or "coupled," to each other to achieve the desired functionality, and any two components capable of being so associated can also be viewed as being "couplable" to each other to achieve the desired functionality. Specific examples of couplable components include but are not limited to physically mateable and/or physically interacting components and/or wirelessly interactable and/or wirelessly interacting components and/or logically interacting and/or logically interactable components.

Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” and the like). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases "at least one" and "one or more" to introduce claim recitations. However, the use of such phrases should not be construed to imply that the introduction of a claim recitation by the indefinite articles "a" or "an" limits any particular claim containing such introduced claim recitation to inventions containing only one such recitation, even when the same claim includes the introductory phrases "one or more" or "at least one" and indefinite articles such as "a" or "an" (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of "two recitations," without other modifiers, typically means at least two recitations, or two or more recitations). Furthermore, in those instances where a convention analogous to “at least one of A, B, and C, and the like” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, and the like). In those instances where a convention analogous to “at least one of A, B, or C, and the like” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, and the like). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the above description, it is clear that the inventive concepts disclosed herein are well adapted to carry out the objects and to attain the advantages mentioned herein as well as those inherent in the inventive concepts disclosed herein. While presently preferred embodiments of the inventive concepts disclosed herein have been described for purposes of this disclosure, it will be understood that numerous changes may be made which will readily suggest themselves to those skilled in the art and which are accomplished within the broad scope and coverage of the inventive concepts disclosed and claimed herein.

What is claimed:

1. A system comprising:
one or more processors; and
a memory, wherein the one or more processors execute program instructions maintained on the memory causing the one or more processors to:
receive input data;
classify a domain of the input data;
identify constraints associated with the domain;
generate structured constraint representations from the input data and the constraints, wherein the input data is transformed into the structured constraint representations;
apply a contextual weighting to the constraints in the structured constraint representations;
construct a constrained inference execution state using the structured constraint representations; and
execute a probabilistic model using the constrained inference execution state to generate an output.

2. The system of claim 1, wherein the input data is transformed into the structured constraint representations prior to executing the probabilistic model.

3. The system of claim 1, wherein the program instructions maintained on the memory cause the one or more processors to adapt the contextual weighting based on a profile prior to applying the contextual weighting to the constraints.

4. The system of claim 3, wherein the profile comprises at least one of user-level modifiers or system-level modifiers.

5. The system of claim 1, wherein the constrained inference execution state governs behavior of the probabilistic model during inference.

6. The system of claim 1, wherein the one or more processors construct the constrained inference execution state using the structured constraint representations in response to applying the contextual weighting to the constraints in the structured constraint representations.

7. The system of claim 1, wherein the structured constraint representations comprise at least one of a vector-based representation, a rule-based representation, or a hybrid representation.

8. The system of claim 1, wherein the one or more processors transform the input data to the structured constraint representations by masking or omitting identifying attributes.

9. The system of claim 1, wherein transforming the constraints to the structured constraint representations is deterministic.

10. The system of claim 1, wherein the one or more processors validate the output for adherence to the constraints.

11. The system of claim 1, wherein the one or more processors adjust at least one of the constraints or the contextual weighting based on the output in a feedback loop.

12. The system of claim 1, wherein a size of the constrained inference execution state is abstracted and reduced from the input data.

13. The system of claim 1, wherein the one or more processors do not modify weights of the probabilistic model.

14. The system of claim 1, wherein the one or more processors are implemented across a distributed computing environment.

15. The system of claim 1, wherein the probabilistic model does not receive the input data.

16. The system of claim 1, wherein the probabilistic model is a large language model.

17. The system of claim 16, wherein the large language model is one of a pre-operative tool, a patient-discharge tool, a dynamic-recovery-plan-generator tool, a progress-tracking tool, a symptom-management tool, or a medical-training-and-simulation tool.

18. The system of claim 17, wherein the input data comprises a patient profile, wherein the output comprises a recovery plan.

19. The system of claim 16, wherein the input data comprises a food description and a taste profile, wherein the output includes a wine recommendation for the food description.

20. A method comprising:
receiving input data;
classifying a domain of the input data;
identifying constraints associated with the domain;
generating structured constraint representations from the input data and the constraints, wherein the input data is transformed into the structured constraint representations;
applying a contextual weighting to the constraints in the structured constraint representations;
constructing a constrained inference execution state using the structured constraint representations; and
executing a probabilistic model using the constrained inference execution state to generate an output.
